(19) United States
(12) Patent Application Publication
(10) Pub. No.: US 2022/0176568 A1
(43) Pub. Date: Jun. 9, 2022

(54) INFORMATION PROCESSING DEVICE, MOBILE BODY, AND MOBILE-BODY-STATE DETERMINATION METHOD

(71) Applicant: SONY GROUP CORPORATION, TOKYO (JP)

(72) Inventors: TETSUYA NARITA, TOKYO (JP); TAKARA KASAI, TOKYO (JP); RYUTA HORIE, TOKYO (JP)

(21) Appl. No.: 17/436,491

(22) PCT Filed: Mar. 4, 2020
(86) PCT No.: PCT/JP2020/009046

§ 371 Date: Sep. 3, 2021

(30) Foreign Application Priority Data
Mar. 14, 2019 (JP) 2019-046738

(51) Int. Cl. B25J 13/08; B25J 9/16; B25J 9/14; B64C 39/02

(52) U.S. Cl. CPC B25J 13/081; B25J 13/085; B25J 9/1694; B64C 2201/18; B25J 13/089; B64C 39/024; B25J 9/14

(57) ABSTRACT

An information processing device (10) includes a sensing section (140) that senses a pressure variation of a fluid filling a deformable filled section (130) that is provided to a portion of a leg of a mobile body (100) that is in either a contact state or a non-contact state at which portion the leg contacts an external environment, and a determining section (150) that determines a state of the leg of the mobile body (100) on the basis of the pressure variation of the fluid sensed by the sensing section (140).

### TECHNICAL FIELD

The present disclosure relates to an information processing device, a mobile body, and a mobile-body-state determination method.

### BACKGROUND ART

There are mobile bodies that have a trunk section and two or more legs, for example. PTL 1 discloses a robot apparatus that is provided with a switch for sensing a force applied to a tip of a leg protruding from a body and can accept input to the switch.

### CITATION LIST

### Patent Literature

### [PTL 1]

Japanese Patent Laid-open No. 2003-71757

### SUMMARY

### Technical Problems

In the conventional technology described above, if a mechanical switch is provided to a tip of a leg, the shape of the tip of the leg is limited undesirably, and it is difficult to diversify the leg. In addition, regarding autonomous movement-type robots having legs that are in either a contact state or a non-contact state, there is a demand for diversification of the structure of tips of the legs at which the legs come into contact.

In view of this, the present disclosure provides an information processing device, a mobile body, and a mobile-body-state determination method that can allow diversification of the structure of legs of a mobile body that are in either a contact state or a non-contact state.

### Solution to Problems

In order to solve the problems described above, an information processing device according to one aspect of the present disclosure includes a sensing section that senses a pressure variation of a fluid filling a deformable filled section that is provided to a portion of a leg of a mobile body that is in either a contact state or a non-contact state at which portion the leg contacts an external environment, and a determining section that determines a state of the leg on the basis of the pressure variation sensed by the sensing section.

In addition, a mobile body according to one aspect of the present disclosure includes a leg that is in either a contact state or a non-contact state, a deformable filled section that is provided to a portion of the leg at which the leg contacts an external environment, a sensing section that senses a pressure variation of a fluid filling the filled section, and a determining section that determines a state of the leg on the basis of the pressure variation sensed by the sensing section.

In addition, a mobile-body-state determination method according to one aspect of the present disclosure performed by a computer includes sensing, by a sensing section, a pressure variation of a fluid filling a deformable filled section provided to a portion of a leg of a mobile body that is in either a contact state or a non-contact state at which portion the leg contacts an external environment, and determining a state of the leg on the basis of the sensed pressure variation.

### BRIEF DESCRIPTION OF THE DRAWINGS

FIG. 1 is a perspective view for explaining one example of a mobile body according to a first embodiment.

FIG. 2 is a figure depicting one example of a configuration of the mobile body according to the first embodiment.

FIG. 3 is a figure depicting one example of configurations of a control section and a drive section of an information processing device according to the first embodiment.

FIG. 4 is a flowchart depicting one example of a processing procedure executed by the information processing device according to the first embodiment.

FIG. 5 is a figure depicting an example of a relation between the mobile body and pressure changes of a filled section according to the first embodiment.

FIG. 6 is a figure depicting one example of the configuration of the mobile body according to a modification example (1) of the first embodiment.

FIG. 7 is a flowchart depicting one example of a setting procedure executed by the information processing device according to the modification example (1) of the first embodiment.

FIG. 8 is a figure depicting an example of a relation between legs of the mobile body and pressure changes of filled sections according to a modification example (3) of the first embodiment.

FIG. 9 is a figure depicting one example of the configuration of the mobile body according to a modification example (4) of the first embodiment.

FIG. 10 is a figure depicting another example of contact sections of the mobile body according to a modification example (5) of the first embodiment.

FIG. 11 is a figure depicting one example of the configuration of the mobile body according to a second embodiment.

FIG. 12 is a figure depicting an example of a relation between operation of the mobile body and pressure changes of a filled section according to the second embodiment.

FIG. 13 is a figure depicting one example of the configuration of the mobile body according to a third embodiment.

FIG. 14 is a figure depicting an example of a relation between operation of the mobile body and pressure changes of filled sections according to the third embodiment.

FIG. 15 is a flowchart depicting one example of a processing procedure executed by the information processing device according to the third embodiment.

FIG. 16 is a figure depicting one example of the configuration of the mobile body according to a modification example (1) of the third embodiment.

FIG. 17 is a figure depicting one example of a relation between the mobile body and an external environment according to the modification example (1) of the third embodiment.

FIG. 18 is a figure depicting one example of a relation between a pressure of a filled section and an external environment according to a modification example (2) of the third embodiment.

FIG. 19 is a figure depicting one example of a relation between a pressure of a filled section and a leg position according to a modification example (3) of the third embodiment.

FIG. 20 is a figure depicting one example of a relation between pressure variations and a state of a leg according to a modification example (4) of the third embodiment.

FIG. 21 is a flowchart depicting one example of a processing procedure executed by the information processing device according to the modification example (4) of the third embodiment.

FIG. 22 is a perspective view for explaining one example of the mobile body according to a fourth embodiment.

FIG. 23 is a figure depicting one example of the configuration of the mobile body according to the fourth embodiment.

FIG. 24 is a figure depicting one example of the configuration of the control section of the information processing device according to the fourth embodiment.

FIG. 25 is a flowchart depicting one example of a processing procedure executed by the information processing device according to the fourth embodiment.

FIG. 26 is a figure depicting examples of operation according to landing of the mobile body and an external environment according to the fourth embodiment.

FIG. 27 is a hardware configuration diagram depicting one example of a computer that realizes functionalities of the information processing device.

### DESCRIPTION OF EMBODIMENTS

Hereinafter, embodiments of the present disclosure are explained in detail on the basis of the figures. Note that identical parts are given identical reference signs in the following embodiments so as to avoid repetitions of the same explanations.

### First Embodiment

### [Overview of Mobile Body According to First Embodiment]

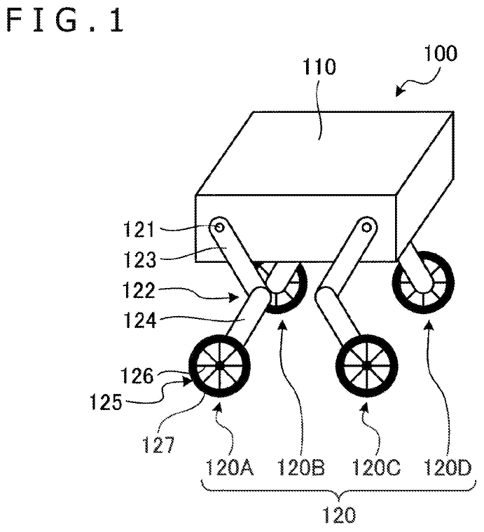

FIG. 1 is a perspective view for explaining one example of a mobile body according to a first embodiment. For example, a mobile body 100 depicted in FIG. 1 is a robot that has plural legs 120 and is capable of autonomous movement. Each of the plural legs 120 is in either a contact state or a non-contact state. For example, the mobile body 100 is in either a contact state where tips of the legs 120 or the like are in contact with an external environment or a non-contact state where the tips of the legs 120 or the like are not in contact with the external environment. The external environment includes a path on which the mobile body 100 moves. For example, the external environment includes a ground, a floor, a stairway, an obstacle, or the like. For example, the mobile body 100 may include a drone, a cart, a vehicle, or the like whose legs are in either a contact state or a non-contact state.

In the example depicted in FIG. 1, the mobile body 100 has a body 110 and four legs 120. That is, the mobile body 100 is a mobile robot having four limbs. For example, the body 110 is a trunk of the mobile body 100. For example, the body 110 has a device that controls autonomous movement and the like. In addition, when distinctions are made among the four legs 120 in the following explanation, the four legs 120 are referred to as a leg 120A, a leg 120B, a leg 120C, and a leg 120D, as appropriate.

The legs 120 are portions that protrude from the body 110 and are used for supporting or moving the body 110. Each leg 120 has a first joint 121, a second joint 122, a first link 123, a second link 124, and a contact section 125. In the example depicted in FIG. 1, a configuration of the legs 120 is depicted in a simplified form. Actually, the shapes, numbers, arrangement, and the like of joints and links can be set as appropriate such that the legs 120 have a desired degree of freedom.

For example, the first joint 121 and the second joint 122 are provided with actuators and are configured such that they can be rotated by driving of the actuators. The first link 123 is provided rotatably relative to the body 110 by means of the first joint 121. The second link 124 is provided rotatably relative to the first link 123 by means of the second joint 122. The contact section 125 is provided to the tip of the leg 120 such that it can contact the external environment. In the example depicted in FIG. 1, the contact section 125 is a wheel and provided rotatably to the second link 124. The contact section 125 has an approximately disc-like wheel 126 and an elastic member 127 covering an outer circumference of the wheel 126. The wheel 126 includes a metallic member and is provided rotatably to the second link 124. The elastic member 127 has elasticity and includes a rubber member or the like, for example. The elastic member 127 is formed as a hollow member such that it deforms in a case that it comes into contact with the external environment. In the present embodiment, the contact section 125 has a configuration that can be rotated by a motor, an output shaft of a motor, or the like, for example.

Driving of the actuators of the first joint 121 and the second joint 122 is controlled by the body 110, and rotation angles of the first link 123 and the second link 124 are thereby controlled, so that driving of the leg 120 is controlled. Accordingly, the mobile body 100 controls, from the body 110, driving of the leg 120A, the leg 120B, the leg 120C, and the leg 120D, to realize walking (movement) by using the leg 120A, the leg 120B, the leg 120C, and the leg 120D.

### [Configuration of Mobile Body According to First Embodiment]

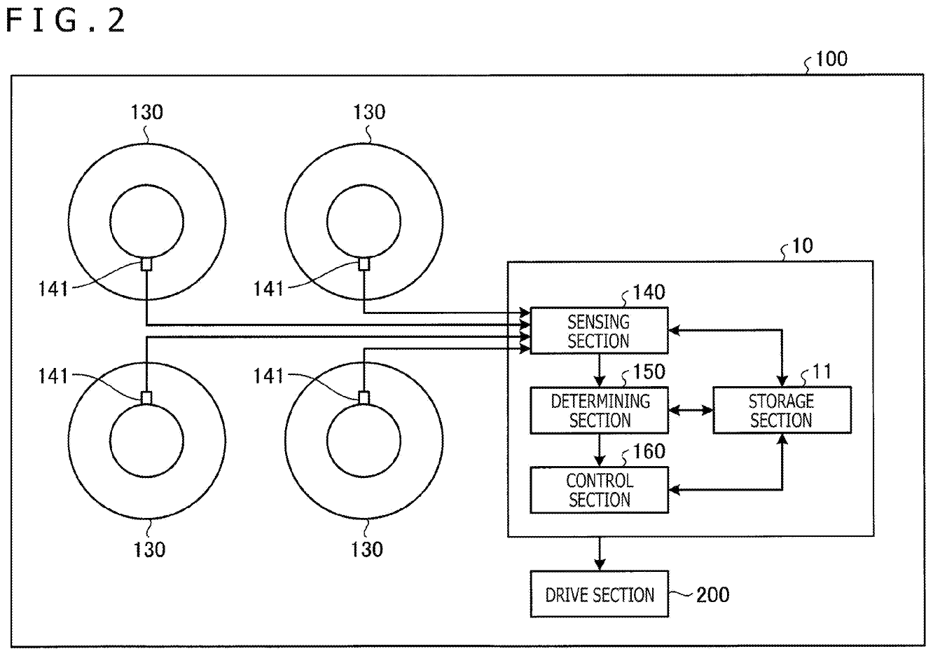

FIG. 2 is a figure depicting one example of a configuration of the mobile body according to the first embodiment. As depicted in FIG. 2, the mobile body 100 includes plural filled sections 130, an information processing device 10, and a drive section 200. The drive section 200 drives each drivable part of the mobile body 100. The drive section 200 has actuators to drive the first joints 121 and the second joints 122 of the legs 120. The drive section 200 is electrically connected with the information processing device 10 and is controlled by the information processing device 10. In addition, the drive section 200 drives motors or the like to thereby rotate the contact sections 125 which are wheels. That is, the mobile body 100 according to the first embodiment has a configuration that enables switching between running movement by using the wheels provided to the legs 120 and walking movement by using the legs 120.

Each of the plural filled sections 130 is provided to one of the plural legs 120. The filled sections 130 are provided deformably to portions of the legs 120 at which the legs 120 contact the external environment. The filled sections 130 are made deformable by being formed as ring-like closed tubes with elastic members, for example. The filled sections 130 are formed such that their inner spaces can be filled with a fluid. The fluid includes a gas, a liquid, or the like, for example. The filled sections 130 are provided between the wheels 126 and the elastic members 127 of the contact sections 125. For example, in a case that the contact sections 125 of the mobile body 100 are tires, the filled sections 130 can be formed as tire tubes. Then, the filled sections 130 deform along with the elastic members 127 when the elastic members 127 come into contact with the external environment. Thereby, internal pressures of the filled sections 130 change according to deformation caused by the contact with the external environment. While the filled sections 130 are explained as being housed in the inner spaces of the elastic members 127 in the present embodiment, the filled sections 130 may be provided to the legs 120 in a state that the filled sections 130 are exposed, for example.

The filled sections 130 have configurations that enable adjustment of internal air pressures. By adjusting the air pressures of the filled sections 130, it is possible to change an area of contact and a friction force of contact of the mobile body 100 with the external environment at the legs 120. As a result, the filled sections 130 can give a degree of freedom at the tips of the legs 120 and also can contribute to simplification of the control of the mobile body 100.

For example, the information processing device 10 is a dedicated or general-purpose computer. The information processing device 10 includes a storage section 11, a sensing section 140, a determining section 150, and a control section 160. For example, the information processing device 10 is provided to the body 110 of the mobile body 100. In the present embodiment, each processing section of the sensing section 140, the determining section 150, and the control section 160 is realized by a program stored in the information processing device 10 being executed by a CPU (Central Processing Unit), an MCU (Micro Control Unit), or the like by using a RAM (Random Access Memory) or the like as a work area, for example. In addition, each processing section may be realized by an integrated circuit such as an ASIC (Application Specific Integrated Circuit) or an FPGA (Field-Programmable Gate Array), for example.

The storage section 11 stores various types of data. For example, the storage section 11 can store data representing a sensing result of the sensing section 140. The storage section 14 is electrically connected with the sensing section 140, the determining section 150, and the control section 160. The storage section 11 stores a program, setting data, and the like for controlling the mobile body 100. The setting data includes a setting threshold for determining pressure variations, for example.

The storage section 11 is a semiconductor memory element such as a RAM or a flash memory, a hard disk, an optical disk, or the like, for example. Note that the storage section 11 may be provided outside the mobile body 100. Specifically, the storage section 11 may be provided in a cloud server connected to the information processing device 10 via a network.

The sensing section 140 senses a pressure variation of the fluid filling each of the plural filled sections 130. The sensing section 140 acquires information regarding the internal pressures of the filled sections 130 and senses pressure variations on the basis of the pressure information. While it is explained in the present embodiment that the sensing section 140 has plural sensors 141 each of which is provided in the inner space of one of the plural filled sections 130 and outputs fluid-pressure information, this is not the sole example. In addition, for example, in a case that the filled sections 130 are filled with a gas, the sensors 141 used are pressure sensors that can sense air pressures. For example, in a case that the filled sections 130 are filled with a liquid, the sensing section 140 uses pressure sensors that can sense hydraulic pressures. The sensing section 140 senses a pressure and a pressure variation of each of the plural filled sections 130. The sensing section 140 is electrically connected with the determining section 150 and outputs pressure information including a sensing result to the determining section 150.

Note that, in a case that the contact sections 125 of the mobile body 100 are tires, the sensing section 140 may have a configuration that acquires pressure information from the mobile body, the tires, or the like without using the sensors 141. In addition, the sensing section 140 may be provided in the inner space of each of the plural filled sections 130.

The determining section 150 determines the state of the legs 120 of the mobile body 100 on the basis of pressure variations sensed by the sensing section 140. In a case that variations of the internal pressures of the filled sections 130 occur, the determining section 150 determines that the legs 120 have made a transition to the contact state or the non-contact state. The determining section 150 can use plural contact determination methods. For example, if pressure variations that make pressure values represented by pressure information equal to or larger than a preset threshold are sensed in a case that the legs 120 are in the non-contact state, the determining section 150 determines that the legs 120 have made a transition to the contact state. For example, if pressure variations that make pressure values represented by pressure information smaller than a predetermined threshold are sensed in a case that the legs 120 are in the contact state, the determining section 150 determines that the legs 120 have made a transition to the non-contact state. The determining section 150 determines the state of each of the plural legs 120. The determining section 150 is electrically connected with the control section 160 and outputs determination information representing a result of the determination to the control section 160. For example, the determination information represents a result of the determination regarding each of the plural legs 120.

The control section 160 controls driving of the legs 120 of the mobile body 100 on the basis of a determination result of the determining section 150. On the basis of the determination result of the determining section 150, the control section 160 recognizes the state of the four legs 120 and controls driving of the legs 120 of the mobile body 100 by controlling the drive section 200. In a case that the determination result of the determining section 150 represents that a leg 120 is in the contact state, the control section 160 performs first control according to the contact state. The first control is force control of the leg 120 because the leg 120 is in the contact state, that is, in a support-leg state. In addition, in a case that the determination result of the determining section 150 represents that a leg 120 is in the non-contact state, the control section 160 performs second control according to the non-contact state. The second control is position control of the leg 120 because the leg 120 is in the non-contact state, that is, in a swing-leg state.

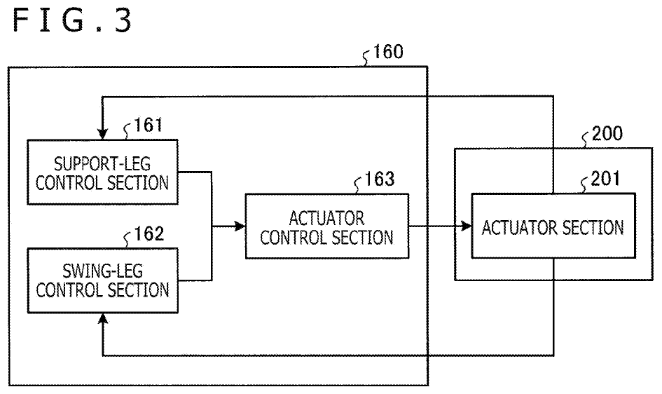

FIG. 3 is a figure depicting one example of configurations of the control section 160 and the drive section 200 of the information processing device 10 according to the first embodiment. The control section 160 depicted in FIG. 3 includes a support-leg control section 161, a swing-leg control section 162, and an actuator control section 163. The support-leg control section 161 and the swing-leg control section 162 are executed selectively on the basis of a determination result of the determining section 150. The support-leg control section 161 plans action of the legs 120 in the contact state and outputs, to the actuator control section 163, torque, a speed, a position command, and the like of the first control according to the plan. The swing-leg control section 162 plans action of the legs 120 in the non-contact state and outputs, to the actuator control section 163, torque, a speed, a position command, and the like of the second control according to the plan. On the basis of the input torque, speed, position command, and the like, the actuator control section 163 outputs a current to drive an actuator section 201 to the drive section 200. Then, the actuator section 201 feeds back torque, a force, an angle value, and the like according to the driving to the support-leg control section 161 and the swing-leg control section 162. As a result, the information processing device 10 performs driving according to the state of the plural legs 120, to thereby realize walking by using the legs 120 of the mobile body 100.

Configuration examples of the mobile body 100 and the information processing device 10 according to the first embodiment are explained thus far. Note that the configurations described above explained by using FIG. 2 and FIG. 3 are merely examples, and the configurations of the mobile body 100 and the information processing device 10 according to the present embodiment are not limited to those examples. The functional configurations of the mobile body 100 and the information processing device 10 according to the present embodiment can be modified flexibly in accordance with specifications and use.

### [Processing Procedure of Information Processing Device According to First Embodiment]

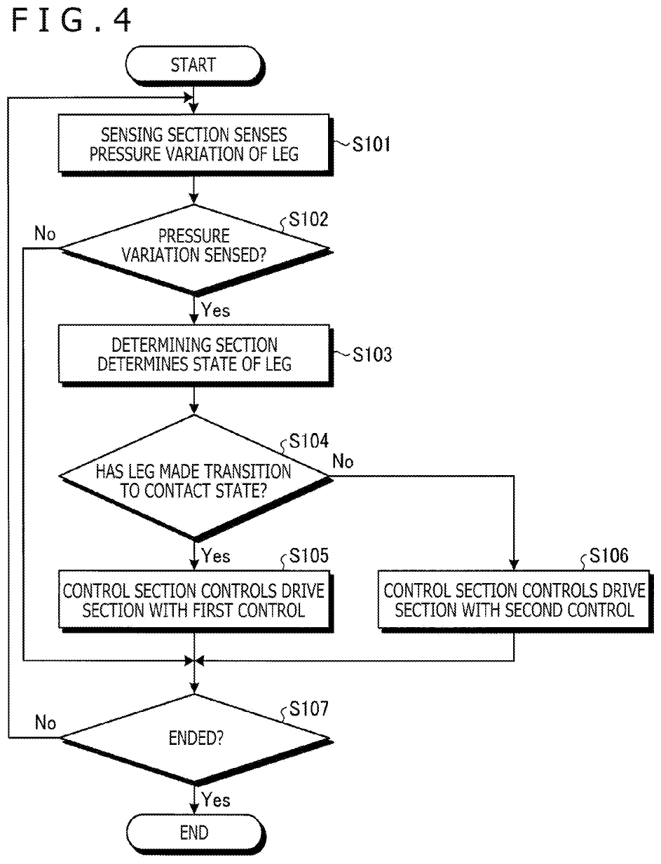

Next, one example of a processing procedure of the information processing device 10 according to the first embodiment is explained. FIG. 4 is a flowchart depicting one example of the processing procedure executed by the information processing device 10 according to the first embodiment. The processing procedure depicted in FIG. 4 is realized by the information processing device 10 executing a program. The processing procedure depicted in FIG. 4 is executed by the information processing device 10 for each of the plural legs 120.

As depicted in FIG. 4, in the information processing device 10, the sensing section 140 senses a pressure variation of a leg 120 (Step S101). For example, the information processing device 10 senses a pressure variation of the leg 120 according to a change from the non-contact state to the contact state or a change from the contact state to the non-contact state, and stores the sensing result on the storage section 11. The sensing result includes information representing whether or not a pressure variation is sensed, for example. For example, in a case that a pressure variation is sensed, the sensing result includes information representing which of the changes the pressure variation corresponds to. Then, the information processing device 10 proceeds to the process at Step S102.

On the basis of the sensing result at Step S101, the information processing device 10 determines whether or not a pressure variation is sensed (Step S102). In a case that it is determined that a pressure variation is not sensed (No at Step S102), the information processing device 10 proceeds to the process at Step S107 mentioned below. In addition, in a case that it is determined that a pressure variation is sensed (Yes at Step S102), the information processing device 10 proceeds to the process at Step S103.

In the information processing device 10, the determining section 150 determines the state of the leg 120 (Step S103). For example, on the basis of the sensed pressure variation, the information processing device 10 determines whether the leg 120 is in the contact state or the non-contact state and stores the determination result on the storage section 11. Then, the information processing device 10 proceeds to the process at Step S104.

On the basis of the determination result at Step S103, the information processing device 10 determines whether or not the leg 120 has made a transition to the contact state (Step S104). If it is determined that the leg 120 has made a transition to the contact state (Yes at Step S104), the information processing device 10 proceeds to the process at Step S105. In the information processing device 10, the control section 160 controls the drive section 200 with the first control (Step S105). As a result, the control section 160 causes the drive section 200 to drive the leg 120 with the force control. Then, the information processing device 10 proceeds to the process at Step S107 mentioned below.

If it is determined that the leg 120 has not made a transition to the contact state (No at Step S104), the leg 120 has made a transition to the non-contact state, and so the information processing device 10 proceeds to the process at Step S106. In the information processing device 10, the control section 160 controls the drive section 200 with the second control (Step S106). As a result, the control section 160 causes the drive section 200 to drive the leg 120 with the position control. Then, the information processing device 10 proceeds to the process at Step S107.

The information processing device 10 determines whether or not to end the process (Step S107). For example, in a case that the information processing device 10 has received an instruction to end the operation of the mobile body 100, the information processing device 10 determines to end the process. In a case that it is determined not to end the process (No at Step S107), the information processing device 10 returns to the process at Step S101 explained already and continues the processing procedure from Step S101. In addition, in a case that it is determined to end the process (Yes at Step S107), the information processing device 10 ends the processing procedure depicted in FIG. 4.

### [Operation of Mobile Body According to First Embodiment]

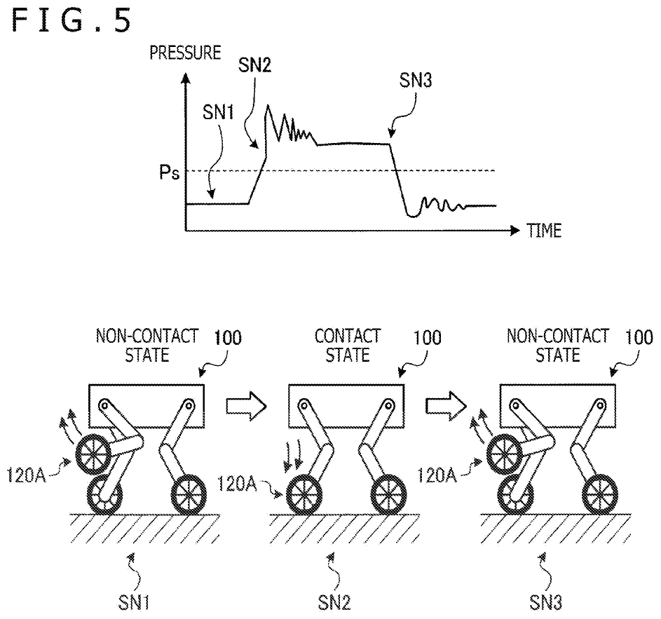

Next, one example of operation of the mobile body 100 is explained with reference to FIG. 5. FIG. 5 is a figure depicting an example of a relation between the mobile body and pressure changes of a filled section 130 according to the first embodiment. In a graph depicted in FIG. 5, the vertical axis represents pressure, and the horizontal axis represents time. In the example depicted in FIG. 5, the graph depicts one example of transitions of the state of the leg 120A of the mobile body 100 and pressure changes.

In a scene SN1 depicted in FIG. 5, the mobile body 100 has made the state of the leg 120A the non-contact state. Because the filled section 130 of the leg 120A is not in contact with the external environment in this case, the sensing section 140 of the information processing device 10 senses a pressure value smaller than a setting threshold Ps. Then, in a scene SN2, the mobile body 100 drives the drive section 200 to cause the leg 120A to make a transition from the non-contact state to the contact state. In this case, the leg 120A contacts a ground (external environment). Thereby, the filled section 130 deforms, and a pressure variation to increase the pressure of the fluid filling the filled section 130 occurs. Because the filled section 130 of the leg 120A contacts the external environment and a pressure variation occurs, the sensing section 140 of the leg 120A senses a pressure value larger than the setting threshold Ps. As a result, the information processing device 10 determines that the leg 120A is in the contact state on the basis of the sensing result of the sensing section 140. In other words, the information processing device 10 determines that the leg 120A has made a transition from the non-contact state to the contact state.

In a scene SN3, the mobile body 100 drives the drive section 200 to cause the leg 120A to make a transition from the contact state to the non-contact state. In this case, the leg 120A detaches from the ground (external environment). Thereby, an effect of causing the filled section 130 to return to its original shape occurs, and a pressure variation to reduce the pressure value of the fluid filling the filled section 130 occurs. Because a pressure variation due to the detachment of the filled section 130 of the leg 120A from the external environment occurs, the sensing section 140 of the leg 120A senses a pressure value smaller than the setting threshold Ps. As a result, the information processing device 10 determines that the leg 120A is in the non-contact state on the basis of the sensing result of the sensing section 140. In other words, the information processing device 10 determines that the leg 120A has made a transition from the contact state to the non-contact state. Then, the information processing device 10 performs similar determinations also for the other legs 120B, 120C, and 120D.

As mentioned above, the information processing device 10 according to the first embodiment senses pressure variations of the fluid filling the deformable filled sections 130 provided to portions of the legs 120 of the mobile body 100 that are in either the contact state or the non-contact state at which portions the legs 120 contact the external environment. The information processing device 10 determines the state of the legs on the basis of the sensed pressure variations. Thereby, only by providing the filled sections 130 to the contact portions of the legs 120, the information processing device 10 can determine whether or not the legs 120 are in the contact state. That is, the information processing device 10 makes it unnecessary to provide contact switches or the like for sensing contact to the legs 120, or to simplify the structure of the legs 120. In addition, the information processing device 10 can determine the state of the legs 120 without complicating the structure even if the contact portions of the legs 120 are enlarged. As a result, the information processing device 10 makes it possible to provide the filled sections 130 with shapes according to the contact portions of the legs 120, and so can allow diversification of the structure of the legs 120 of the mobile body 100. In addition, the information processing device 10 makes it possible to absorb an impact caused by contact between the external environment and the legs 120 by the filled sections 130 for sensing pressure variations, and so can suppress malfunctions caused by the impact.

In addition, the information processing device 10 includes the control section 160 that controls driving of the legs 120 of the mobile body 100 on the basis of a determination result of the determining section 150. Thereby, the information processing device 10 can control driving of the legs 120 according to the contact state or the non-contact state of the legs 120 of the mobile body 100. As a result, the information processing device 10 can perform driving according to the contact state even if wheels are provided to the tips of the legs 120, and so can contribute to further diversification of the legs 120.

In addition, in the information processing device 10, the control section 160 performs the first control according to the contact state in a case that a determination result of the determining section 150 represents that the legs 120 are in the contact state, and performs the second control according to the non-contact state in a case that the determination result represents that the legs 120 are in the non-contact state. Thereby, the information processing device 10 performs the first control such as the force control of the legs 120 in a case that the legs 120 of the mobile body 100 are in the contact state, and performs the second control such as the position control of the legs 120 in a case that the legs 120 of the mobile body 100 are in the non-contact state. As a result, the information processing device 10 can switch to control according to the state of the legs 120 even if the mobile body 100 includes plural legs 120, and so can allow diversification of the plural legs 120.

In addition, in the information processing device 10, the determining section 150 determines the state of the legs 120 on the basis of a result of comparison between a preset threshold and a pressure variation sensed by the sensing section 140. Thereby, the information processing device 10 can determine the state of the legs 120 by comparing a pressure variation and the threshold. As a result, the information processing device 10 can suppress an increase of processing load even if the number of the plural legs 120 increases, and so can allow diversification of the plural legs 120.

### Modification Example (1) of First Embodiment

For example, in a case that the contact sections 125 of the legs 120 of the mobile body 100 are tires, there is a possibility that the fluid of the filled sections 130 flows out, is influenced by ageing, and so on. Because of this, the information processing device 10 has a functionality of adjusting the setting threshold Ps at a predetermined timing. For example, the predetermined timing includes the timing of initial setting, the timing of maintenance, and the like.

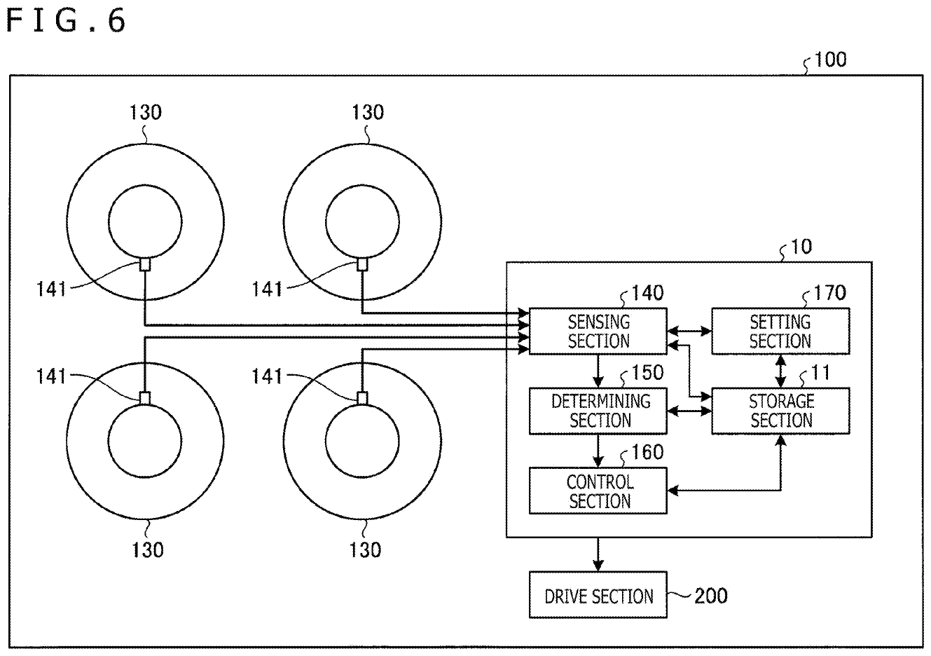

FIG. 6 is a figure depicting one example of the configuration of the mobile body 100 according to a modification example (1) of the first embodiment. As depicted in FIG. 6, the mobile body 100 includes the plural filled sections 130, the information processing device 10, and the drive section 200. The information processing device 10 includes the storage section 11, the sensing section 140, the determining section 150, the control section 160, and a setting section 170.

The setting section 170 sets the setting threshold Ps corresponding to the mobile body 100. On the basis of pressures of the filled sections 130 sensed by the sensing section 140 when the legs 120 are in the contact state and pressures of the filled sections 130 sensed by the sensing section 140 when the legs 120 are in the non-contact state, the setting section 170 sets the setting threshold Ps. While, for example, it is explained that the setting section 170 sets the setting threshold Ps to internally dividing points of the pressures that are sensed when the legs 120 are in the contact state and the pressures that are sensed when the legs 120 are in the non-contact state, the threshold setting method is not limited to this.

### [Setting Threshold Setting Procedure According to Modification Example (1) of First Embodiment]

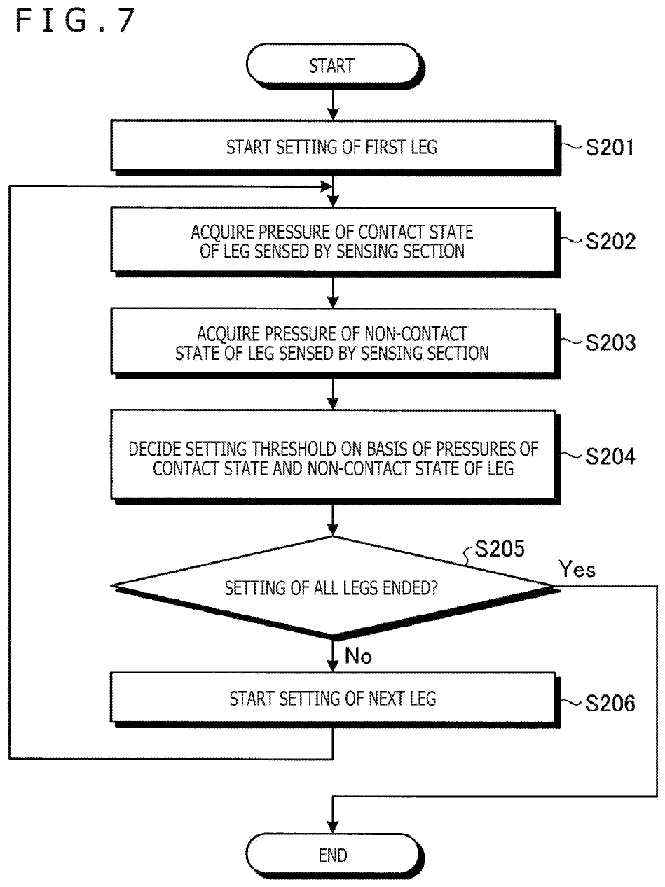

Next, one example of a procedure of setting the setting threshold Ps of the information processing device 10 according to the modification example (1) of the first embodiment is explained. FIG. 7 is a flowchart depicting one example of a setting procedure executed by the information processing device 10 according to the modification example (1) of the first embodiment. The processing procedure depicted in FIG. 7 is realized by the information processing device 10 executing a program.

As depicted in FIG. 7, the information processing device 10 starts setting of the first leg 120 (Step S201). For example, in a case that the leg 120A is set as the first leg 120, the information processing device 10 starts setting of the leg 120A. The information processing device 10 drives the drive section 200 such that the leg 120 changes to the contact state and to the non-contact state. Then, when the process of Step S201 ends, the information processing device 10 proceeds to the process at Step S202.

The information processing device 10 acquires a pressure sensed by the sensing section 140 when the leg 120 is in the contact state (Step S202). Then, the information processing device 10 acquires a pressure sensed by the sensing section 140 when the leg 120 is in the non-contact state (Step S203). Then, the information processing device 10 decides the setting threshold Ps on the basis of the pressures that are sensed when the leg 120 is in the contact state and the non-contact state (Step S204). For example, the information processing device 10 decides the setting threshold Ps on the basis of an internally dividing point of the pressure that is sensed when the leg 120 is in the contact state and the pressure that is sensed when the leg 120 is in the non-contact state. Then, the information processing device 10 proceeds to the process at Step S205.

The information processing device 10 determines whether or not setting of all the legs 120 has ended (Step S205). In a case that it is determined that setting of all the legs 120 has not ended (No at Step S205), the information processing device 10 proceeds to the process at Step S206. The information processing device 10 starts setting of the next leg 120 (Step S206). For example, the information processing device 10 starts setting in the order of the leg 120B, the leg 120C, and the leg 120D. The information processing device 10 drives the drive section 200 such that the setting-target leg 120 changes to the contact state and to the non-contact state. Then, the information processing device 10 returns to the process at Step S202 explained already and continues the processing procedure from Step S202.

In addition, in a case that it is determined that setting of all the legs 120 has ended (Yes at Step S205), the information processing device 10 ends the processing procedure depicted in FIG. 7. The information processing device 10 functions as the setting section 170 by executing the processing procedure depicted in FIG. 7.

As mentioned above, in the information processing device 10 according to the modification example (1) of the first embodiment, the setting section 170 sets the thresholds on the basis of pressures of the filled sections 130 sensed by the sensing section 140 when the legs 120 are in the contact state and pressures of the filled sections 130 sensed by the sensing section 140 when the legs 120 are in the non-contact state. Thereby, the information processing device 10 can set the thresholds suited for situations even if the fluid in the filled sections 130 flows out, is influenced by ageing, and so on. As a result, the information processing device 10 can suppress deterioration of precision in determining the state of the legs 120 on the basis of pressure variations of the filled sections 130, even if the filled sections 130 are provided to the legs 120.

### Modification Example (2) of First Embodiment

While it is explained in the first embodiment that the information processing device 10 determines the state of the legs 120 on the basis of pressure variations that are generated when the legs 120 make a transition from the non-contact state to the contact state and makes a transition from the contact state to the non-contact state, this is not the sole example.

For example, if the filled sections 130 provided to the legs 120 of the mobile body 100 come into contact with the external environment, they exhibit pressure values that increase, attenuate while fluctuating, and then stabilize, as represented by SN2 in the graph in FIG. 5. Similarly, if the filled sections 130 detach from the external environment, they exhibit pressure values that increase, attenuate while fluctuating, and then stabilize, as represented by SN3 in the graph in FIG. 5.

The information processing device 10 according to the modification example (2) of the first embodiment can use a method of sensing fluctuation of pressure variations. The sensing section 140 of the information processing device 10 may sense pressure variations on the basis of whether or not there is fluctuation of sensed pressure values. Thereby, the sensing section 140 can suppress sensing of temporarily changing pressure changes due to noise or the like, as pressure variations.

The determining section 150 may calculate the variance of pressure values sensed by the sensing section 140 and, in a case that the variance is equal to or larger than a certain value, determine that there is contact or detachment of the filled sections 130. For example, in a case that the mobile body 100 is walking at a constant speed, the legs 120 contact the external environment at constant intervals. In this case, the determining section 150 may capture pressure values sensed by the sensing section 140 in a time series and, on the basis of the intervals of fluctuation of the pressure variations, determine that there is contact or detachment of the legs 120.

As mentioned above, the information processing device 10 according to the modification example (2) of the first embodiment can determine the state of the plural legs 120 on the basis of fluctuation of pressures sensed by the sensing section 140. As a result, in a case that pressures have changed for a reason other than contact or detachment of the legs 120 with or from the external environment, the information processing device 10 can exclude the pressure changes, and so the determination precision can be improved.

### Modification Example (3) of First Embodiment

For example, in a case that the mobile body 100 includes plural legs 120, the determining section 150 of the information processing device 10 may determine the state of the legs 120 on the basis of relative changes of the pressures of the fluid filling the plural filled sections 130.

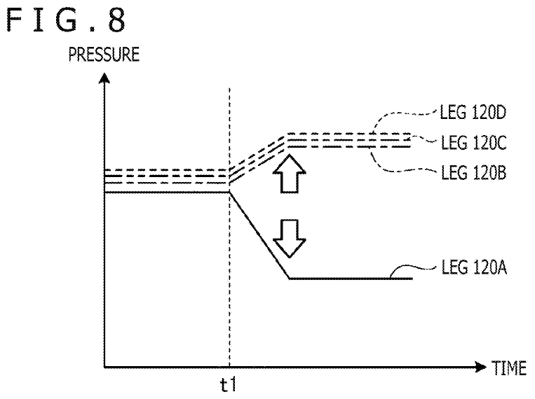

FIG. 8 is a figure depicting an example of a relation between the legs 120 of the mobile body 100 and pressure changes of the filled sections 130 according to a modification example (3) of the first embodiment. In a graph depicted in FIG. 8, the vertical axis represents pressure, and the horizontal axis represents time.

In the example depicted in FIG. 8, the mobile body 100 is activated at a time t1, makes the state of the leg 120A the non-contact state, and keep the state of the other legs 120B, 120C, and 120D in the contact state. In this case, the sensing section 140 of the information processing device 10 can sense a decrease of the pressure of the filled section 130 of the leg 120A and increases of the pressures of the filled sections 130 of the legs 120B, 120C, and 120D. Then, on the basis of a relation of the increases and decreases represented by the sensing result of the sensing section 140, the determining section 150 can determine whether the plural legs 120 are in the contact state or the non-contact state.

As mentioned above, the information processing device 10 according to the modification example (3) of the first embodiment can determine the state of the plural legs 120 on the basis of a relation of increases and decreases of the pressures of the filled sections 130 each provided to the mobile body 100. As a result, the information processing device 10 can suppress the influence of the fluid flowing out of the filled sections 130 or ageing and stabilize the determination precision.

### Modification Example (4) of First Embodiment

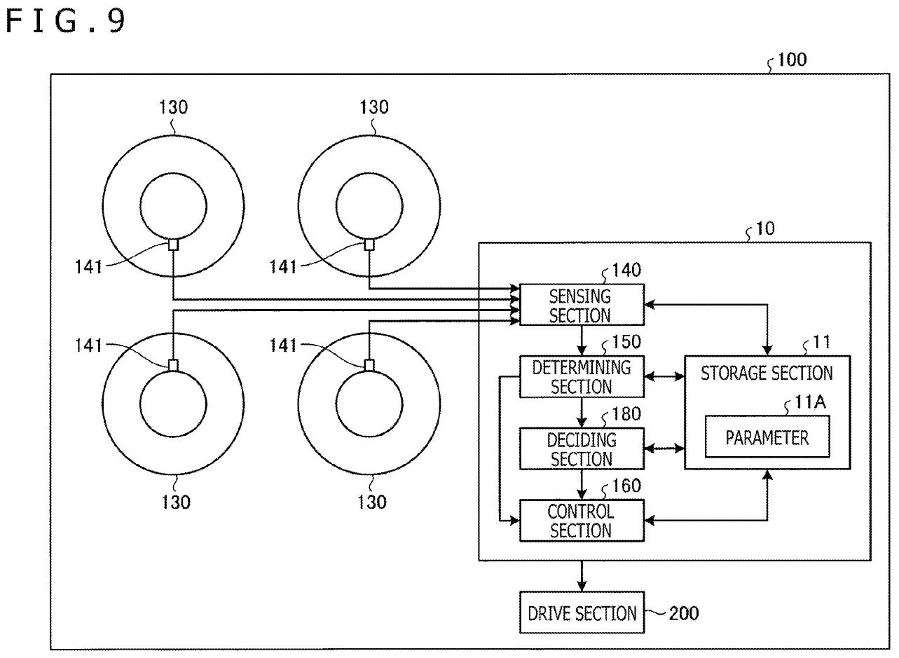

FIG. 9 is a figure depicting one example of the configuration of the mobile body 100 according to a modification example (4) of the first embodiment. As depicted in FIG. 9, the mobile body 100 includes the plural filled sections 130, the information processing device 10, and the drive section 200. The information processing device 10 includes the storage section 11, the sensing section 140, the determining section 150, the control section 160, and a deciding section 180.

The storage section 11 has parameters 11A stored thereon. The parameters 11A are used for control of the drive section 200. The parameters 11A include various types of parameters such as control gains or impedance of the actuator sections 201 of the legs 120, for example. In the present embodiment, the parameters 11A include first parameters used for the first control (force control) and second parameters used for the second control (position control).

On the basis of a determination result of the determining section 150, the deciding section 180 decides parameters to be used by the control section 160. For example, if the determining section 150 determines that the legs 120 are in the contact state, the deciding section 180 decides the first parameters in the parameters 11A of the storage section 11 as parameters to be used by the control section 160. In addition, if the determining section 150 determines that the legs 120 are in the non-contact state, the deciding section 180 decides the second parameters in the parameters 11A of the storage section 11 as parameters to be used by the control section 160. Then, the deciding section 180 outputs the decided parameters to the control section 160.

On the basis of the parameters decided by the deciding section 180, the control section 160 controls the drive section 200 to thereby control driving of the legs 120 of the mobile body 100. For example, in a case that the parameters are the first parameters, the control section 160 performs the first control (force control). As a result, in a case that the legs 120 are in the contact state, the control section 160 lowers the control gains, performs impedance control, and so on. In addition, in a case that the parameters 11A are the second parameters, the control section 160 performs the second control (position control). As a result, in a case that the legs 120 are in the non-contact state, the control section 160 increases the control gains.

On the basis of torque, speeds, position commands, and the like corresponding to the parameters decided by the deciding section 180, the control section 160 outputs currents to drive the actuator sections 201 to the drive section 200. As a result, the information processing device 10 performs driving according to the state of the plural legs 120, to thereby realize walking by using the legs 120 of the mobile body 100.

As mentioned above, the information processing device 10 according to the modification example (4) of the first embodiment can drive the legs 120 by using parameters corresponding to the state of the legs 120 determined by the determining section 150. As a result, the information processing device 10 can switch control of the legs 120 only by changing parameters, and so the configuration of the control section 160 can be simplified.

### Modification Example (5) of First Embodiment

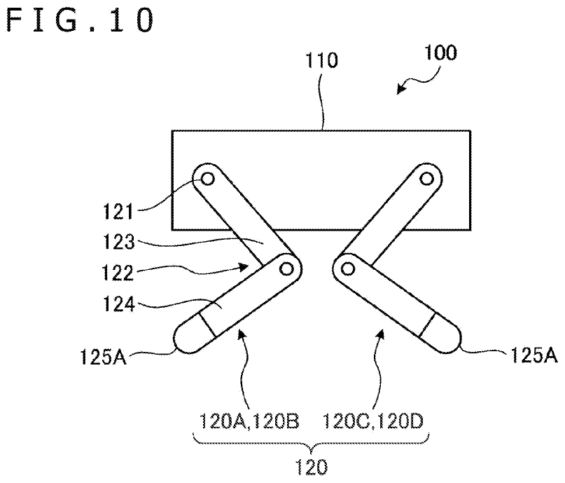

FIG. 10 is a figure depicting another example of the contact sections 125 of the mobile body 100 according to a modification example (5) of the first embodiment. As depicted in FIG. 10, the mobile body 100 the mobile body 100 has the body 110 and the four legs 120. Each of the four legs 120 has the first joint 121, the second joint 122, the first link 123, the second link 124, and a contact section 125A.

The contact section 125A includes an elastic member such that it deforms due to physical contact with the external environment. The contact section 125A houses therein the filled section 130 mentioned above. In the example depicted in FIG. 10, the contact section 125A is formed to protrude toward the tip of the leg 120, but this is not the sole example. For example, the contact section 125A may have a shape similar to the tip of a leg of a human or an animal. In addition, the filled section 130 may have a configuration protruding from the contact section 125A like a pad of an animal, for example.

Note that the modification example (1) to the modification example (5) of the first embodiment may be applied to the mobile body 100 of another embodiment or modification example.

### Second Embodiment

### [Configuration Example of Mobile Body According to Second Embodiment]

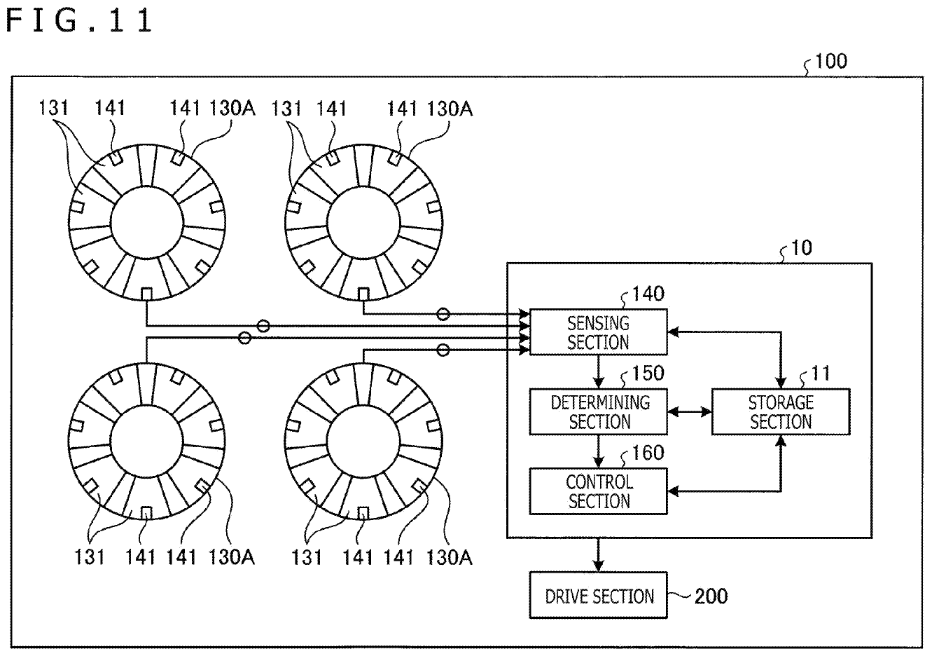

Next, a second embodiment is explained. FIG. 11 is a figure depicting one example of the configuration of the mobile body 100 according to the second embodiment. As depicted in FIG. 11, the mobile body 100 includes plural filled sections 130A, the information processing device 10, and the drive section 200. The information processing device 10 includes the storage section 11, the sensing section 140, the determining section 150, and the control section 160.

Each of the plural filled sections 130A is provided corresponding to one of the plural legs 120. The filled sections 130A are provided to portions of the legs 120 at which the legs 120 contact the external environment. The filled sections 130A are made deformable by being formed as ring-like tubes with elastic members, for example. Each of the filled sections 130A is divided into plural segments 131 each having a closed inner space. The plural segments 131 are formed uniformly. In the present embodiment, each filled section 130A is divided into plural segments 131 by plural partitions that are arrayed in a circumferential direction. Each of the plural segments 131 of the filled sections 130A is filled with a fluid. Each of the plural segments 131 deforms due to an external force and has a configuration whose internal pressure changes according to the deformation.

The sensing section 140 of the information processing device 10 senses a pressure variation of the fluid filling each of the segments 131 of the plural filled sections 130. The sensing section 140 acquires information regarding the internal pressures of the segments 131 and senses pressure variations on the basis of the pressure information. The sensing section 140 has the plural sensors 141 each provided to one of the plural segments 131 of the filled sections 130. For example, in a case that the segments 131 are filled with a gas, the sensors 141 used are pressure sensors that can sense air pressures. For example, in a case that the segments 131 are filled with a liquid, the sensing section 140 uses pressure sensors that can sense hydraulic pressures. The sensing section 140 senses a pressure and a pressure variation of the fluid filling each of the segments 131 of the plural filled sections 130. By sensing pressure variations of the plural segments 131, the sensing section 140 improves positional resolution of the sensing. In the present embodiment, the information processing device 10 associates the sensors 141 with the arrangement of the segments 131 at the contact sections 125 in advance, in order to specifically recognize the contact positions of the contact sections 125.

The determining section 150 of the information processing device 10 determines the state of the legs 120 of the mobile body 100 on the basis of a segment where a pressure variation is sensed by the sensing section 140. The determining section 150 identifies a sensor 141 that has sensed the pressure variation and identifies a segment 131 of a filled section 130 associated with the sensor 141. For example, in a case that a supposed angle at the time of the rotation of the identified segment 131 matches the actual angle of the contact section 125, the determining section 150 determines that the portion where there has been the pressure variation is in contact. The supposed angle means the angle of the segment 131 that is supposed to be formed at the contact section 125 having been driven, for example. In addition, in a case that the supposed angle of the identified segment 131 does not match the actual angle of the contact section 125, the determining section 150 determines that there has been a collision of the segment 131 with the external environment. That is, the determining section 150 can make a determination while distinguishing between contact and a collision with the external environment. On the basis of the positional relation of a segment where the sensing section 140 has sensed a pressure variation, the determining section 150 determines whether there has been a collision of a leg 120.

A configuration example of information processing device 10 according to the second embodiment is explained thus far. Note that the configuration described above explained by using FIG. 11 is merely one example, and the configuration of the information processing device 10 according to the second embodiment is not limited to the example. The functional configuration of the information processing device 10 according to the second embodiment can be modified flexibly in accordance with specifications and use.

### [Operation of Mobile Body According to Second Embodiment]

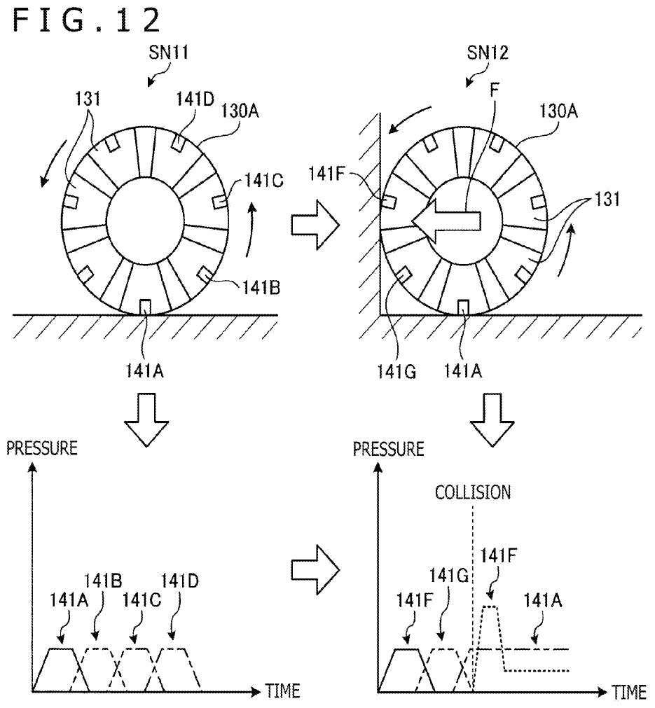

Next, one example of operation of the mobile body 100 according to the second embodiment is explained with reference to FIG. 12. FIG. 12 is a figure depicting an example of a relation between operation of the mobile body 100 and pressure changes of a filled section 130 according to the second embodiment. In a graph depicted in FIG. 12, the vertical axis represents pressure, and the horizontal axis represents time. In the example depicted in FIG. 12, the graph depicts one example of the state and changes of pressure variations of segments of the filled section 130A.

In a scene SN11 depicted in FIG. 12, the mobile body 100 moves by rotating a contact section 125, and thereby the filled section 130A provided to the contact section 125 also rotates while part of the filled section 130A comes into contact with the external environment. For example, it is supposed that, at the contact section 125, a segment 131 of a sensor 141A, a segment 131 of a sensor 141B, a segment 131 of a sensor 141C, and a segment 131 of a sensor 141D have contacted the external environment in this order. In this case, the sensing section 140 of the information processing device 10 sequentially senses a pressure variation of the sensor 141A, a pressure variation of the sensor 141B, a pressure variation of the sensor 141C, and a pressure variation of the sensor 141D as depicted in a graph of the scene SN11.

Next, in a scene SN12, the mobile body 100 is continuing movement by using the contact section 125. Then, the mobile body 100 stops when the portion of a segment 131 of a sensor 141F collides with a step or the like of the external environment with a force F, in a state that the segment 131 of the sensor 141A of the contact section 125 is in contact with the external environment. In this case, the sensing section 140 of the information processing device 10 senses a pressure variation of the sensor 141A and also senses a pressure variation of the sensor 141F larger than the pressure variation of the sensor 141A, as depicted in a graph of the scene SN12. Then, the determining section 150 of the information processing device 10 determines that there has been a collision at the contact section 125 of the leg 120 at the portion of the segment 131 provided with the sensor 141F in the sensors 141A and 141F where the pressure variations are sensed by the sensing section 140. As a result, the information processing device 10 controls the drive section 200 such that the leg 120 that is determined to have collided with the external environment avoids the collision.

Note that in a case that the pressure variation of the sensor 141A sensed by the sensing section 140 is similar to the pressure variation of the sensor 141F sensed by the sensing section 140, the determining section 150 of the information processing device 10 may determine that a segment 131 which is not in contact with the external environment is a portion where there is a collision on the basis of the arrangement relation of the segments 131 and the state of driving of the contact section 125.

As mentioned above, in the information processing device 10 according to the second embodiment, the sensing section 140 senses pressure variations of a fluid filling each of the plural segments 131 in a case that each of the inner spaces of the filled sections 130 is divided into the plural closed segments 131. In the information processing device 10, the determining section 150 determines the state of the legs 120 on the basis of a segment 131 where a pressure variation is sensed by the sensing section 140. Thereby, the information processing device 10 can recognize a relation between a position where a leg 120 is in contact with the external environment and pressure variations, on the basis of the arrangement of the segments 131 of the filled sections 130. As a result, by using the filled sections 130 each of which is divided into the plural segments 131, the information processing device 10 can improve resolution regarding a position where a pressure variation is sensed, and so can contribute to further diversification of the legs 120.

In addition, in the information processing device 10, the determining section 150 determines that there is a collision of a leg 120 on the basis of the position of a segment 131 of a filled section 130 where a pressure variation is sensed by the sensing section 140. Thereby, for example, in a case that the position of a segment where a pressure variation is sensed is different from a contact position which should be in contact with the external environment, the information processing device 10 can determine that there is a collision of a leg 120. As a result, the information processing device 10 can determine whether there is contact or a collision of a leg 120 with the external environment only by using the filled sections 130A without complicating the structure of the legs 120, and so can contribute to further diversification of the legs 120.

Note that the second embodiment may also be applied to the information processing device 10 of another embodiment or modification example, or the like.

### Third Embodiment

### [Configuration Example of Mobile Body According to Third Embodiment]

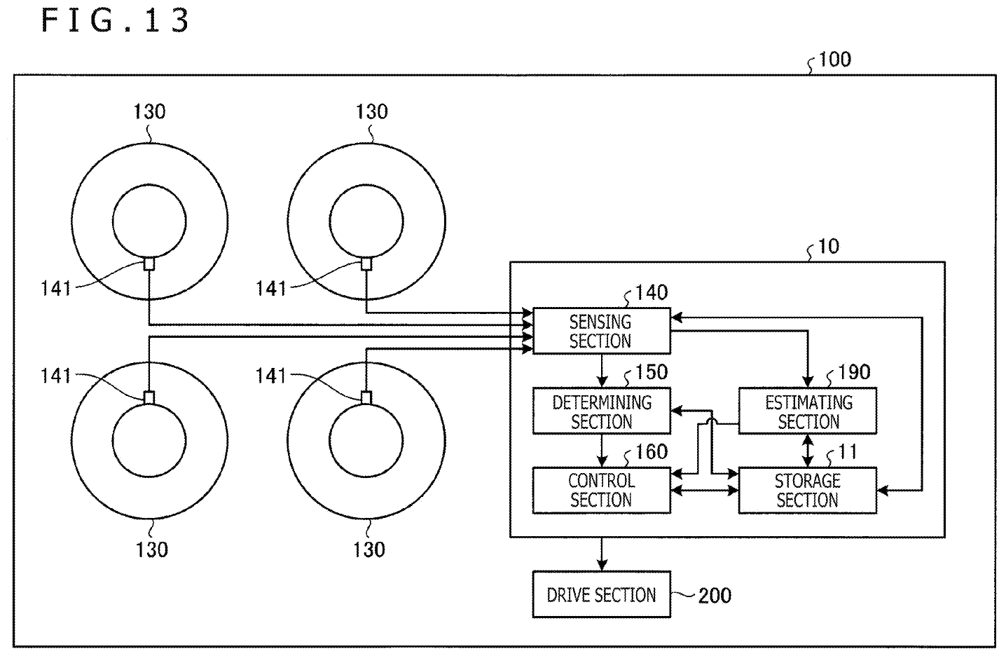

Next, a third embodiment is explained. FIG. 13 is a figure depicting one example of the configuration of the mobile body according to the third embodiment. As depicted in FIG. 13, the mobile body 100 includes the plural filled sections 130, the information processing device 10, and the drive section 200. The information processing device 10 includes the storage section 11, the sensing section 140, the determining section 150, the control section 160, and an estimating section 190.

The estimating section 190 estimates the state of the external environment with which the legs 120 of the mobile body 100 are in contact, on the basis of pressure variations sensed by the sensing section 140. The estimating section 190 estimates the state of the external environment with which the leg 120 is in contact as to unevenness of the external environment, on the basis of a pressure variation sensed by the sensing section 140. For example, the state of the external environment includes a state as to whether or not a ground on which the mobile body 100 is moving has a planar surface, a state as to whether or not the ground has a recess, and a state as to whether or not the ground has a protrusion.

For example, in a case that the mobile body 100 is moving, if the contact sections 125 contact an uneven surface of the external environment, distribution of pressures sensed by the sensing section 140 changes. In addition, the distribution of pressures sensed by the sensing section 140 changes depending also on the shape of the uneven surface of the external environment, the moving speed of the mobile body 100, and the like, for example. The estimating section 190 uses an estimation method to estimate the state, unevenness, and the like of the external environment. The estimation method includes an estimation method based on variations of a peak state by using a threshold process, for example. For example, the estimation method includes an estimation method that calculates the variance of pressure variations. For example, the estimation method may include an estimation method that uses frequency analysis, pattern matching by machine learning, or the like.

The control section 160 changes the control of the mobile body 100 on the basis of the state of the external environment estimated by the estimating section 190. If the estimating section 190 estimates that the external environment is uneven, the control section 160 changes the control of the legs 120 to third control according to the unevenness. The third control is control for an uneven surface for the mobile body 100, for example. For example, the control for an uneven surface includes control that changes the moving speed according to the situation of unevenness, control that changes a posture of the mobile body, control that changes control parameters according to the situation of unevenness, and the like. The control that changes the moving speed according to the situation of unevenness is control that reduces the moving speed as changes of the unevenness increase, for example. The control that changes the posture of the mobile body is control that lowers the posture of the mobile body 100 and makes it easier for the mobile body 100 to keep the balance as changes of the unevenness increase, for example. The control that changes the control parameters according to the situation of unevenness is control that reduces position control gains, reduces impedance control gain, and so on as changes of the unevenness increase, for example.

A configuration example of the information processing device 10 according to the third embodiment is explained thus far. Note that the configuration described above explained by using FIG. 13 is merely one example, and the configuration of the information processing device 10 according to the third embodiment is not limited to the example. The functional configuration of the information processing device 10 according to the third embodiment can be modified flexibly in accordance with specifications and use.

### [One Example of Operation and Pressure Variations of Mobile Body According to Third Embodiment]

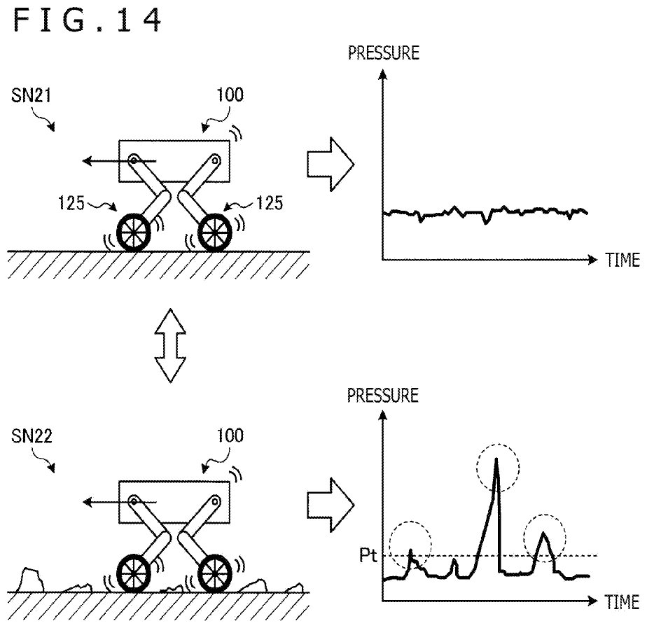

Next, one example of pressure variations sensed by the mobile body 100 according to the third embodiment is explained with reference to FIG. 14. FIG. 14 is a figure depicting an example of a relation between operation of the mobile body 100 and pressure changes of a filled section 130 according to the third embodiment. In a graph depicted in FIG. 14, the vertical axis represents pressure, and the horizontal axis represents time. In the example depicted in FIG. 14, the graph depicts one example of changes of pressure variations in a filled section 130 according to the external environment.

In a scene SN21 depicted in FIG. 14, the mobile body 100 is moving by wheel running by rotating the contact sections 125, in a case that the external environment has a smooth road surface. In this case, the sensing section 140 of the information processing device 10 senses a pressure variation at none of the four sensors 141 as depicted in the scene SN21. In other words, the sensing section 140 senses stable pressure values at the four sensors 141.

Next, in a scene SN22, the mobile body 100 is moving by wheel running by rotating the contact sections 125, in a case that the external environment has an uneven road surface. In this case, in a case that the contact sections 125 come into contact with uneven portions of the external environment as depicted in the scene SN22, the sensing section 140 of the information processing device 10 senses, at the sensors 141, pressure variations according to the shapes, sizes, and the like of the uneven portions. In other words, the sensing section 140 senses pressure variations that change corresponding to the shapes, sizes, and the like of the uneven portions. Thereby, the estimating section 190 of the information processing device 10 estimates whether or not the external environment is uneven, on the basis of pressure variations sensed by the sensing section 140. In the example represented by the scene SN22, the estimating section 190 estimates that the external environment is uneven, in a case that plural pressure variations equal to or larger than a threshold Pt are sensed in a certain length of time. Then, the control section 160 of the information processing device 10 performs control that reduces the running speed of the mobile body 100, for example.

### [Processing Procedure of Information Processing Device According to Third Embodiment]

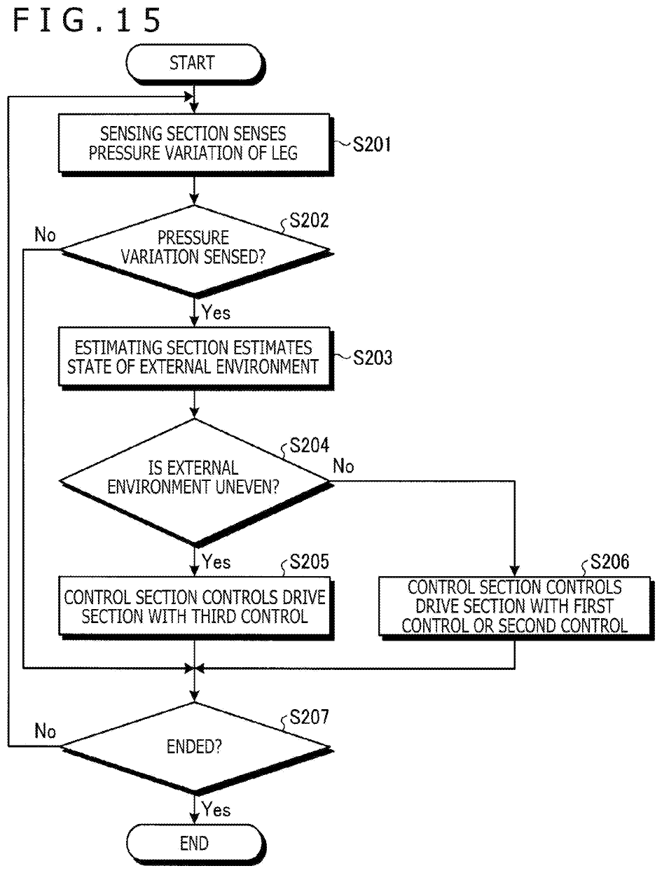

Next, one example of a processing procedure of the information processing device 10 according to the third embodiment is explained. FIG. 15 is a flowchart depicting one example of the processing procedure executed by the information processing device 10 according to the third embodiment. The processing procedure depicted in FIG. 15 is realized by the information processing device 10 executing a program. The processing procedure depicted in FIG. 15 is executed by the information processing device 10 for each of the plural legs 120.

As depicted in FIG. 15, in the information processing device 10, the sensing section 140 senses a pressure variation of a leg 120 (Step S201). Then, on the basis of the sensing result at Step S201, the information processing device 10 determines whether or not a pressure variation is sensed (Step S202). In a case that a pressure variation according to contact of a leg 120 with the external environment is sensed, the information processing device 10 determines that a pressure variation is sensed. In a case that it is determined that a pressure variation is not sensed (No at Step S202), the information processing device 10 proceeds to the process at Step S207 mentioned below. In addition, in a case that it is determined that a pressure variation is sensed (Yes at Step S202), the information processing device 10 proceeds to the process at Step S203. In the information processing device 10, the estimating section 190 estimates the state of the external environment (Step S203). The information processing device 10 stores the estimation result on the storage section 11 and then proceeds to the process at Step S204.

On the basis of the estimation result of the estimating section 190, the information processing device 10 determines whether or not the external environment is uneven (Step S204). If it is determined that the external environment is uneven (Yes at Step S204), the information processing device 10 proceeds to the process at Step S205. In the information processing device 10, the control section 160 controls the drive section 200 with the third control (Step S205). As a result, the control section 160 causes the drive section 200 to drive the legs 120 such that the moving speed of the mobile body 100 is reduced. Then, the information processing device 10 proceeds to the process at Step S207 mentioned below.

In addition, in a case that it is determined that the external environment does not have an uneven surface (No at Step S204), the information processing device 10 proceeds to the process at Step S206. In the information processing device 10, the control section 160 controls the drive section 200 with the first control or the second control (Step S206). As a result, because it is likely that the external environment has a smooth planar surface or the like, the control section 160 causes the drive section 200 to drive the legs 120 by the force control or the position control according to the state of contact with the external environment. Then, the information processing device 10 proceeds to the process at Step S207 mentioned below.

The information processing device 10 determines whether or not to end the process (Step S207). In a case that it is determined not to end the process (No at Step S207), the information processing device 10 returns to the process at Step S201 explained already and continues the processing procedure from Step S201. In addition, in a case that it is determined to end the process (Yes at Step S207), the information processing device 10 ends the processing procedure depicted in FIG. 15.

As mentioned above, in the information processing device 10 according to the third embodiment, the estimating section 190 estimates the state of the external environment with which the legs 120 are in contact, on the basis of pressure variations sensed by the sensing section 140. In the information processing device 10, on the basis of the state of the external environment estimated by the estimating section 190, the control section 160 changes the control of the legs 120 to control according to the state of the external environment. Thereby, the information processing device 10 can estimate the state of the external environment on the basis of pressure variations of the filled sections 130. As a result, the information processing device 10 can estimate the state of the external environment without complicating the structure of the legs 120, and so can contribute to further diversification of the legs 120.

In addition, in the information processing device 10 according to the third embodiment, the estimating section 190 estimates the state of the external environment with which the legs 120 are in contact as to unevenness of the external environment, on the basis of pressure variations sensed by the sensing section 140. In the information processing device 10, if the estimating section 190 estimates that the external environment is uneven, the control section 160 changes the control of the legs 120 to third control according to the unevenness. Thereby, the information processing device 10 can estimate whether or not the external environment has protrusions and recesses on the basis of pressure variations of the filled sections 130. As a result, the information processing device 10 can estimate the state of the external environment as to unevenness of the external environment without complicating the structure of the legs 120, and so can contribute to further diversification of the legs 120.

In addition, in the information processing device 10, the estimating section 190 estimates the state of the external environment with which the legs 120 of the mobile body 100 are in contact as to unevenness of the external environment, on the basis of a pattern of pressure variations sensed by the sensing section 140. Thereby, by estimating unevenness on the basis of a pattern of pressure variations of the filled sections 130, the information processing device 10 can exclude pressure variations caused by noise or the like from targets of estimation. As a result, the information processing device 10 can extract pressure variations of the filled sections 130 caused by the unevenness of the external environment, and so can improve unevenness estimation precision.

In addition, in the information processing device 10, if the estimating section 190 estimates that the external environment is uneven in a case that the mobile body 100 has a configuration that is capable of movement by using wheels provided to the legs 120 and of walking by using the legs 120, the control section 160 performs control that moves the mobile body 100 by using the wheels. Then, in the information processing device 10, if the estimating section 190 estimates that the external environment is not uneven, the control section 160 performs control that causes the mobile body 100 to walk by using the legs 120. Thereby, the information processing device 10 can switch the movement of the mobile body 100 between movement by using the wheels of the mobile body 100 and movement by walking by using the legs 120, according to the state of the external environment as to unevenness of the external environment. As a result, even if the configuration of the legs 120 becomes complicated, the information processing device 10 can determine the state of the legs 120 by using the filled sections 130 and also estimate the state of the external environment as to unevenness of the external environment, and so can contribute to further diversification of the legs 120.

### Modification Example (1) of Third Embodiment

For example, in a case that the contact sections 125 of the legs 120 of the mobile body 100 are tires, the mobile body 100 may be configured to adjust the air pressures of the filled sections 130.

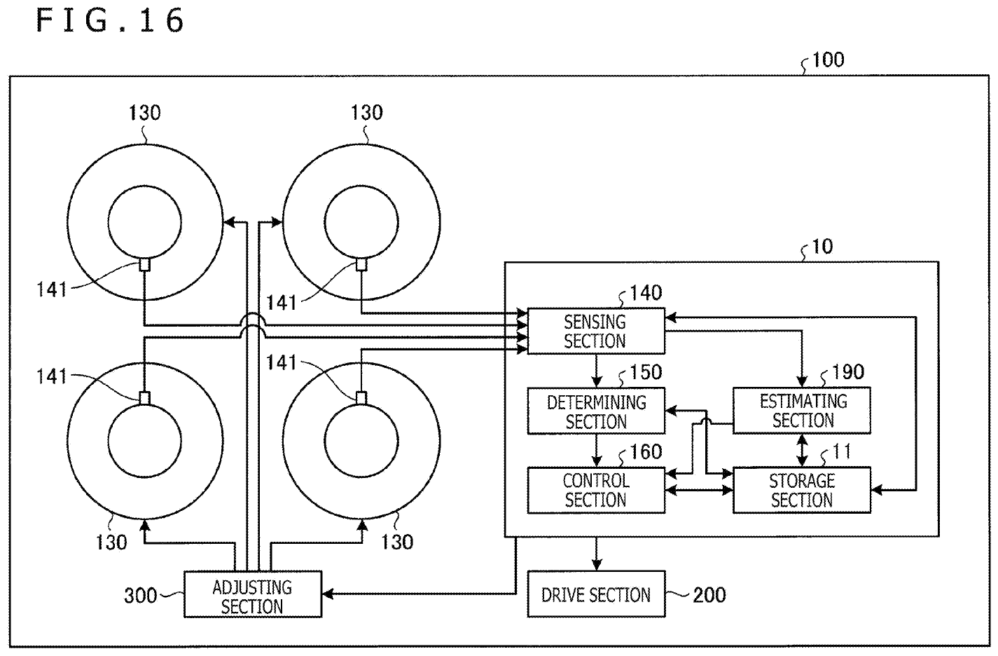

FIG. 16 is a figure depicting one example of the configuration of the mobile body 100 according to a modification example (1) of the third embodiment. As depicted in FIG. 16, the mobile body 100 includes the plural filled sections 130, the information processing device 10, the drive section 200, and an adjusting section 300. As depicted in FIG. 13, the information processing device 10 includes the storage section 11, the sensing section 140, the determining section 150, the control section 160, and the estimating section 190. Note that the adjusting section 300 may be included in the configuration of the information processing device 10.

The adjusting section 300 of the mobile body 100 adjusts the pressure of a fluid filling the inner space of each of the plural filled sections 130. For example, the adjusting section 300 is connected to each of the plural filled sections 130 via a pressure adjusting valve, a compressor, or the like such that the adjusting section 300 can adjust pressures. For example, by controlling opened and closed states of the pressure adjusting valve or the like, the adjusting section 300 fills the filled sections 130 with a fluid from a pump or discharges the fluid from the filled sections 130. The adjusting section 300 is electrically connected with the information processing device 10. For example, operation of the adjusting section 300 is controlled by the control section 160.

If the estimating section 190 estimates that the external environment is uneven, as the control of the legs 120, the control section 160 of the information processing device 10 causes the adjusting section 300 to adjust the internal pressures of the filled sections 130 on the basis of the unevenness. For example, in a case that the external environment is uneven, the control section 160 controls the adjusting section 300 to reduce the internal pressures of the filled sections 130. Thereby, because the area of contact of the contact sections 125 of the legs 120 with the external environment increases, the friction force increases, and also robust control becomes possible according to the situation of a road surface.

### [One Example of Mobile Body and External Environment According to Modification Example (1) of Third Embodiment]

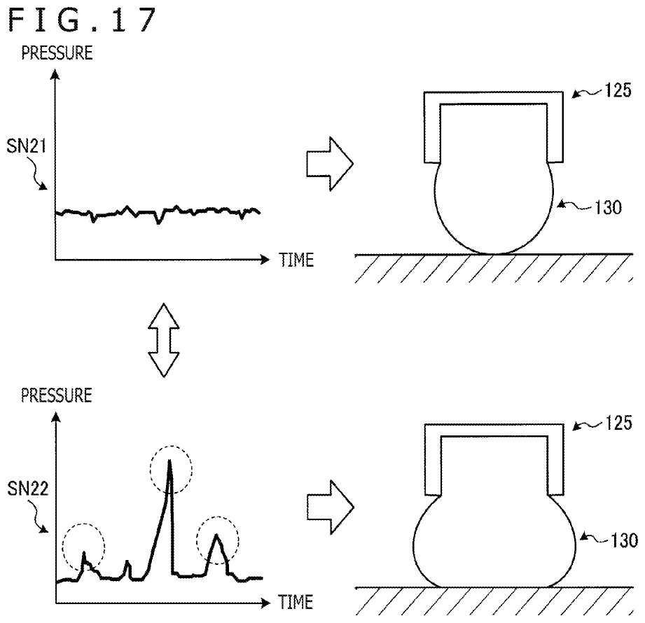

Next, one example of a relation between the mobile body 100 and the external environment according to the modification example (1) of the third embodiment is explained with reference to FIG. 17. FIG. 17 is a figure depicting one example of the relation between the mobile body 100 and the external environment according to the modification example (1) of the third embodiment. A graph depicted in FIG. 17 is identical to the graph depicted in FIG. 14. That is, the example depicted in FIG. 17 depicts examples of operation corresponding to the scenes SN21 and SN22 depicted in FIG. 14.

In the scene SN21 depicted in FIG. 17, the information processing device 10 senses stable pressure values of the four sensors 141 because the external environment of the mobile body 100 has a smooth road surface. In this case, it is not necessary to increase the area of contact between the contact sections 125 of the mobile body 100 and an open-section environment, and so the information processing device 10 causes the adjusting section 300 to operate to make the internal pressures of the filled sections 130 a reference first pressure. Note that, in a case that the internal pressures of the filled sections 130 are the first pressure, the information processing device 10 does not cause the adjusting section 300 to adjust the pressures. In addition, in a case that the internal pressures of the filled sections 130 are not the first pressure, the information processing device 10 causes the adjusting section 300 to adjust the pressures such that the internal pressure of each of the filled sections 130 becomes the first pressure.

Next, in the scene SN22, the information processing device 10 senses pressure variations at the four sensors 141 because the external environment of the mobile body 100 has an uneven road surface. In this case, in order to increase the area of contact between the contact sections 125 of the mobile body 100 and the external environment, the information processing device 10 causes the adjusting section 300 to operate to reduce the internal pressures of the filled sections 130. For example, the adjusting section 300 discharges the fluid from the filled sections 130 to reduce the pressure values to a second pressure such that the internal pressure of each of the plural filled sections 130 becomes the second pressure. The second pressure is a pressure value lower than the first pressure. As a result, the contact sections 125 of the legs 120 of the mobile body 100 have a larger area of contact with the external environment, and so the legs 120 can be stabilized even if the external environment is uneven.

As mentioned above, the information processing device 10 according to the modification example (1) of the third embodiment has the adjusting section 300 that is provided to the mobile body 100 and adjusts the pressures of the fluid filling the inner spaces of the filled sections 130. In this case, in the information processing device 10, if the estimating section 190 estimates that the external environment is uneven, as the control of the legs 120, the control section 160 causes the adjusting section 300 to adjust the internal pressures of the filled sections 130 on the basis of the unevenness. Thereby, the information processing device 10 can adjust the internal pressures of the filled sections 130 according to the unevenness of the external environment. As a result, because the information processing device 10 can change the area of contact and the friction force of contact between the legs 120 of the mobile body 100 and the external environment by adjusting the internal pressures of the filled sections 130, it is possible to attempt to improve the degree of freedom of the contact sections 125 of the legs 120 and also to simplify the control.

### Modification Example (2) of Third Embodiment

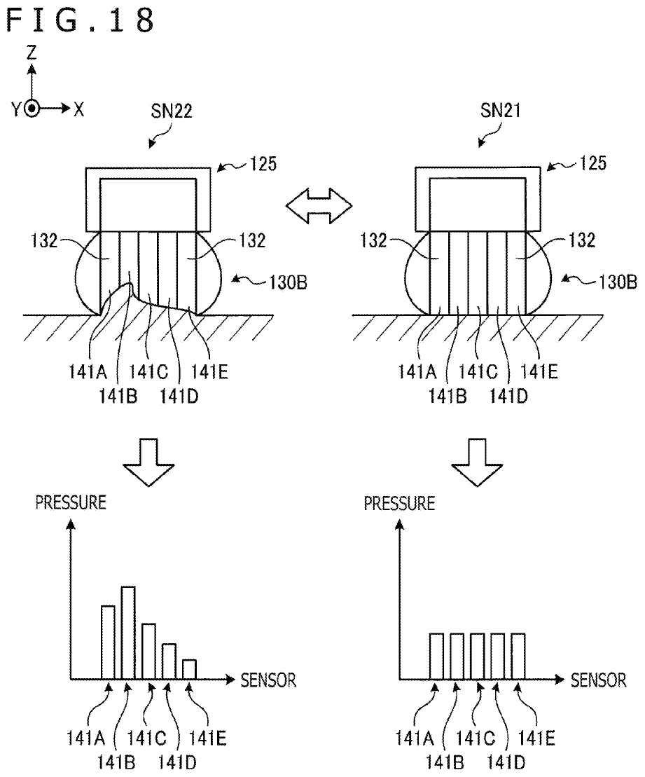

The information processing device 10 according to a modification example (2) of the third embodiment realizes determination about the state of the external environment as to unevenness of the external environment, by another determination method. FIG. 18 is a figure depicting one example of a relation between a pressure of a filled section 130B and the external environment according to the modification example (2) of the third embodiment. In a graph depicted in FIG. 18, the vertical axis represents pressure, and the horizontal axis represents the arrangement of the sensors 141.

The mobile body 100 mentioned above may include plural filled sections 130B depicted in FIG. 18. That is, the mobile body 100 includes the plural filled sections 130B, the information processing device 10, and the drive section 200. As depicted in FIG. 13, the information processing device 10 includes the storage section 11, the sensing section 140, the determining section 150, the control section 160, and the estimating section 190.

Each of the plural filled sections 130B is provided corresponding to one of the plural legs 120. The filled sections 130B are provided to portions of the legs 120 at which the legs 120 contact the external environment. The filled sections 130B are made deformable by being formed as ring-like tubes with elastic members, for example. The filled sections 130B are arrayed in a width direction (X-axis direction) of the contact sections 125 of the mobile body 100, and each of the filled sections 130B has an inner space having plural closed segments 132. The plural segments 132 are provided such that they can rotate freely in a circumferential direction of the contact sections 125 of the legs 120. The plural segments 132 are formed to have uniform sizes. Each of the plural segments 132 of the filled sections 130B is filled with a fluid. Each of the plural segments 132 deforms due to contact with the external environment or the like and has a configuration whose internal pressure changes according to the deformation.

The sensing section 140 of the information processing device 10 senses a pressure variation of the fluid filling each of the segments 132 of the plural filled sections 130B. The sensing section 140 acquires information regarding the internal pressures of the segments 132 and senses pressure variations on the basis of the pressure information. The sensing section 140 has the plural sensors 141 each provided to one of the plural segments 132 of the filled sections 130B. For example, in a case that the segments 132 are filled with a gas, the sensors 141 used are pressure sensors that can sense air pressures. For example, in a case that the segments 132 are filled with a liquid, the sensing section 140 uses pressure sensors that can sense hydraulic pressures. The sensing section 140 senses a pressure and a pressure variation of the fluid filling each of the segments 132 of the plural filled sections 130. By sensing pressure variations of the plural segments 132, the sensing section 140 improves the positional resolution of the sensing. In the example depicted in FIG. 18, the information processing device 10 has sensors 141A, 141B, 141C, 141D, and 141E that are arrayed from left to right in the X-axis direction. In the present embodiment, the information processing device 10 associates the sensors 141 with the arrangement of the segments 132 at the contact sections 125 in advance, in order to specifically recognize the contact positions of the contact sections 125.

The estimating section 190 of the information processing device 10 estimates the state of the external environment with which the legs 120 of the mobile body 100 are in contact, on the basis of a distribution of segments 132 where pressure variations are sensed by the sensing section 140. The estimating section 190 estimates the state of the external environment with which the legs 120 are in contact as to unevenness of the external environment, on the basis of a distribution of pressure variations sensed by the sensing section 140.

For example, in a case that a contact section 125 of the mobile body 100 is in contact with a flat portion of the external environment as depicted in the scene SN21 of FIG. 18, the plural segments 132 of the filled section 130B receive a uniform force. In this case, the sensing section 140 of the information processing device 10 gives uniform pressure values as the values of pressures sensed by the sensors 141A, 141B, 141C, 141D, and 141E. Thereby, because the distribution of pressure variations sensed by the sensing section 140 is uniform, the estimating section 190 estimates that the external environment with which the leg 120 is in contact is a flat portion.

In addition, in a case that a contact section 125 of the mobile body 100 is in contact with a protrusion of the external environment as depicted in the scene SN22, the plural segments 132 of the filled section 130B receive different forces according to the shape of the external environment with which the plural segments 132 are in contact. In this case, the sensing section 140 of the information processing device 10 gives larger pressure values as the values of pressures sensed by the sensors 141A and 141B provided to the segments 132 that are in contact with the protrusion of the external environment. Then, the sensing section 140 gives smaller pressure values as the values of pressures sensed by 141C, 141D, and 141E provided to the segments 132 that have smaller areas of contact with the protrusion. Because there is a large variance of the distribution of pressure variations sensed by the sensing section 140, the estimating section 190 estimates that the external environment with which the leg 120 is in contact has a protrusion.

The estimating section 190 may estimate the degree of unevenness by computing the variance of the distribution of pressure variations. For example, the estimating section 190 may use a method of computing the variance of pressure variations, a method of computing a difference between a maximum value and a minimum value of pressure variations, or the like to estimate the degree of unevenness of the external environment.

As mentioned above, in the information processing device 10 according to the modification example (2) of the third embodiment, the sensing section 140 senses pressure variations of a fluid filling each of the plural segments 132 in a case that each of the inner spaces of the filled sections 130 is divided into the plural closed segments 132. In the information processing device 10, the estimating section 190 estimates the state of the external environment with which the legs 120 of the mobile body 100 are in contact, on the basis of a distribution of segments where pressure variations are sensed by the sensing section 140. Thereby, the information processing device 10 can estimate the state of the external environment with which the legs 120 of the mobile body 100 are in contact, on the basis of a distribution of segments where pressure variations are sensed. As a result, by using the filled sections 130 each of which is divided into the plural segments 132, the information processing device 10 can estimate the state of the external environment with which the legs 120 are in contact as to unevenness, flat, or the like of the external environment, and so can contribute to further diversification of the legs 120.

### Modification Example (3) of Third Embodiment

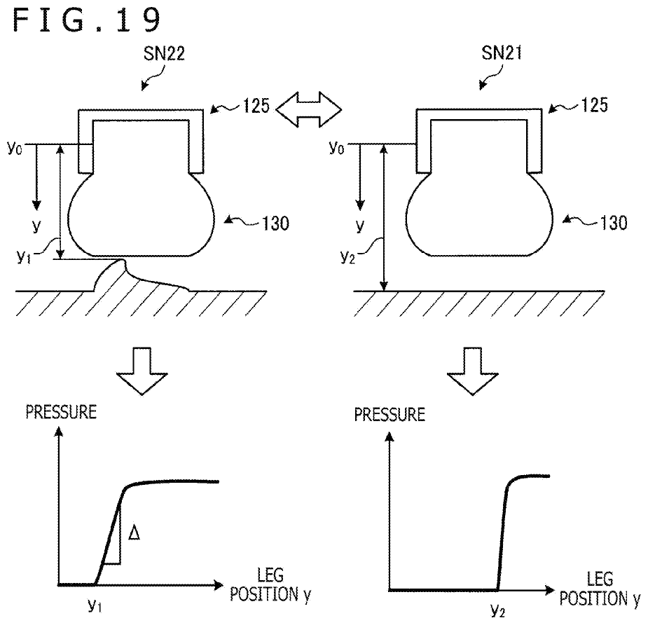

The information processing device 10 according to a modification example (3) of the third embodiment realizes determination about the state of the external environment as to unevenness, flat, or the like of the external environment, by another determination method. FIG. 19 is a figure depicting one example of a relation between a pressure of a filled section 130 and a leg position according to the modification example (3) of the third embodiment. For example, the leg position means a position between a reference position y₀ of a contact section 125 of a leg 120 and the external environment. In a graph depicted in FIG. 19, the vertical axis represents pressure, and the horizontal axis represents a leg position y.

As depicted in FIG. 13, the mobile body 100 includes the plural filled sections 130, the information processing device 10, and the drive section 200. Then, the information processing device 10 includes the storage section 11, the sensing section 140, the determining section 150, the control section 160, and the estimating section 190. That is, the mobile body 100 is different from the mobile body 100 according to the modification example (2) of the third embodiment in that the filled sections 130 of the contact sections 125 of the legs 120 are not divided.

The estimating section 190 of the information processing device 10 estimates the state of the external environment with which the legs 120 of the mobile body 100 are in contact, on the basis of pressure variations sensed by the sensing section 140 and the leg positions y of the legs 120 relative to the reference position y₀. The estimating section 190 estimates the state of the external environment with which the legs 120 are in contact as to unevenness of the external environment, on the basis of pressure variations sensed by the sensing section 140 and the leg positions y. For example, the estimating section 190 acquires information of an angle of a joint of the leg 120 or the like from an encoder or the like, and computes the position of the contact section 125 relative to the reference position y₀ from the angle information. Note that, for example, the estimating section 190 may have a configuration that computes the position of the contact section 125 relative to the reference position y₀ on the basis of a sensing result of an acceleration sensor, a distance sensor, or the like.

For example, in a case that the contact section 125 of the mobile body 100 contacts a flat portion of the external environment as depicted in the scene SN21 of FIG. 19, the value of a pressure sensed by the sensing section 140 of the information processing device 10 increases from a leg position y₂. Thereby, in a case that a pressure variation of a pressure sensed by the sensing section 140 occurs at the leg position y₂, the estimating section 190 estimates that the external environment with which the leg 120 is in contact has a flat portion.

In addition, in a case that the contact section 125 of the mobile body 100 contacts a protrusion of the external environment at a leg position y₁ as depicted in the scene SN22, the value of a pressure sensed by the sensing section 140 of the information processing device 10 increases gradually from the leg position y₁. Then, in a case that the external environment has a protrusion, the timing at which the pressure sensed by the sensing section 140 increases is earlier than that in a case that the external environment does not have a protrusion. In a case that the external environment has a protrusion, a pressure increase gradient A of the pressure sensed by the sensing section 140 is smaller than that in a case that the external environment does not have a protrusion. Thereby, in a case that the leg position y at the start of a pressure variation sensed by the sensing section 140 is the leg position y₁, the estimating section 190 estimates that the external environment with which the leg 120 is in contact has a protrusion. In addition, in a case that the leg position y at the start of a pressure variation sensed by the sensing section 140 is the leg position y₂ and the pressure increase gradient A is smaller than that in a case that the external environment has a flat surface, the estimating section 190 estimates that the external environment with which the leg 120 is in contact has a recess.

Note that, in a case that the mobile body 100 includes plural legs 120, the estimating section 190 may estimate the state of the external environment by comparing the leg positions y of the plural legs 120 at which pressure variations are sensed with each other. For example, in a case that the leg positions y of the plural legs 120 that are in contact with the external environment are different from each other, the estimating section 190 may estimate that the external environment is uneven.

As mentioned above, in the information processing device 10 according to the modification example (3) of the third embodiment, the estimating section 190 estimates the state of the external environment with which the legs 120 of the mobile body 100 are in contact, on the basis of pressure variations sensed by the sensing section 140 and the leg positions y of the legs 120 relative to the reference position y₀. Thereby, the information processing device 10 can estimate the state of the external environment with which the legs 120 of the mobile body 100 are in contact, on the basis of a relation between pressure variations and the positions of the legs 120. As a result, only by using the filled sections 130 with a simple structure, the information processing device 10 can estimate the state of the external environment with which the legs 120 are in contact as to unevenness or the like of the external environment, and so can contribute to further diversification of the legs 120.

### Modification Example (4) of Third Embodiment

In one possible embodiment, the information processing device 10 according to a modification example (4) of the third embodiment can also determine that there is contact with the external environment on the basis of pressure variations, and estimate the state of the external environment and a collision with an object from the pressure variations.

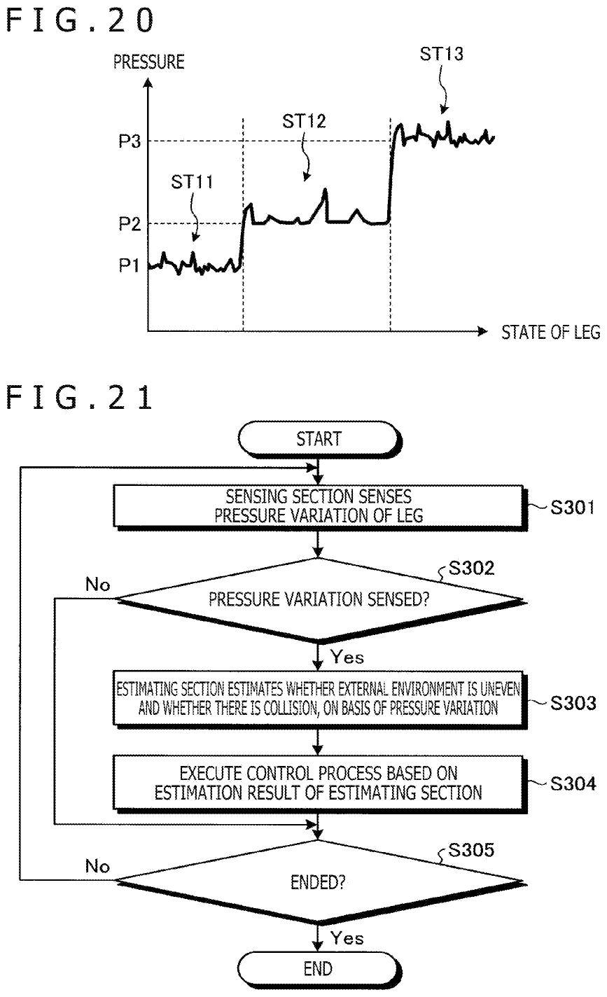

FIG. 20 is a figure depicting one example of a relation between pressure variations and the state of a leg 120 according to the modification example (4) of the third embodiment. In FIG. 20, the vertical axis represents pressure, and the horizontal axis represents the state of the leg. As depicted in FIG. 20, pressure variations generated to a filled section 130 provided to the leg 120 exhibit different values, patterns, and the like in a contact state ST11, an uneven-surface contact state ST12, and a collision state ST13. For example, the contact state ST11 is a state where the leg 120 is in contact with a flat external environment. For example, the uneven-surface contact state ST12 is a state where the leg 120 is in contact with an uneven external environment. For example, the collision state ST13 is a state where the contact section 125 is in contact with an object or the like which is different from an uneven surface.

In the example depicted in FIG. 20, in the case of the contact state ST1, the sensing section 140 of the information processing device 10 senses a pressure variation of a pressure P1. In the case of the uneven-surface contact state ST12, the sensing section 140 senses a pressure variation of a pressure P2. The pressure P2 has a value larger than the value of the pressure P1. In the case of the collision state ST13, the sensing section 140 senses a pressure variation of a pressure P3. The pressure P3 has a value larger than the value of the pressure P2.

As depicted in FIG. 13, the mobile body 100 includes the plural filled sections 130, the information processing device 10, and the drive section 200. Then, the information processing device 10 includes the storage section 11, the sensing section 140, the determining section 150, the control section 160, and the estimating section 190.

In the information processing device 10, the determining section 150 determines the contact state of a leg 120 on the basis of a pressure variation sensed by the sensing section 140. Then, in the information processing device 10, the estimating section 190 estimates whether the external environment is uneven and whether there is a collision of the leg 120 on the basis of a change of the sensed pressure variation. In a case that a pressure variation is a change of the pressure P2, the estimating section 190 estimates that the current state is the uneven-surface contact state ST12. In a case that a pressure variation is a change of the pressure P3, the estimating section 190 estimates that the current state is the collision state ST13.

### [Processing Procedure of Information Processing Device According to Modification Example (4) of Third Embodiment]

Next, one example of a processing procedure of the information processing device 10 according to a modification example (4) of the third embodiment is explained. FIG. 21 is a flowchart depicting one example of the processing procedure executed by the information processing device 10 according to the modification example (4) of the third embodiment. The processing procedure depicted in FIG. 21 is realized by the information processing device 10 executing a program. The processing procedure depicted in FIG. 21 is executed by the information processing device 10 for each of the plural legs 120.

As depicted in FIG. 21, in the information processing device 10, the sensing section 140 senses a pressure variation of a leg 120 (Step S301). Then, on the basis of the sensing result at Step S301, the information processing device 10 determines whether or not a pressure variation is sensed (Step S302). In a case that it is determined that a pressure variation is not sensed (No at Step S302), the leg 120 is not in the contact state ST1, and so the information processing device 10 proceeds to the process at Step S305 mentioned below. In addition, in a case that it is determined that a pressure variation is sensed (Yes at Step S302), the information processing device 10 proceeds to the process at Step S303.

In the information processing device 10, the estimating section 190 estimates whether the external environment is uneven and whether there is a collision of the leg on the basis of the pressure variation (Step S303). For example, the information processing device 10 estimates that the current state is the uneven-surface contact state ST12 in a case that the pressure variation is a change of the pressure P2, and estimates that the current state is the collision state ST13 in a case that the pressure variation is a change of the pressure P3. Then, the information processing device 10 executes a control process based on the estimation result of the estimating section 190 (Step S304). For example, in a case that it is estimated that the current state is the uneven-surface contact state ST12, the information processing device 10 executes a process of causing the drive section 200 to be controlled with the third control, or the like as mentioned above. For example, in a case that it is estimated that the current state is the collision state ST13, the information processing device 10 executes a process of stopping the drive section 200, and avoiding the collision, or the like as mentioned above.

The information processing device 10 determines whether or not to end the process (Step S305). In a case that it is determined not to end the process (No at Step S305), the information processing device 10 returns to the process at Step S301 explained already and continues the processing procedure from Step S301. In addition, in a case that it is determined to end the process (Yes at Step S305), the information processing device 10 ends the processing procedure depicted in FIG. 21.

As mentioned above, in the information processing device 10 according to the second embodiment, the estimating section 190 estimates whether the external environment is uneven and whether there is a collision of a leg 120, on the basis of a change of a pressure variation sensed by the sensing section 140. Thereby, the information processing device 10 can estimate whether the external environment is uneven and whether there is a collision of the leg 120 of the mobile body 100, on the basis of the change of the sensed pressure variation. As a result, only by using the filled sections 130, the information processing device 10 can estimate the state of the external environment with which the legs 120 are in contact as to unevenness of the external environment and estimate whether there is a collision of a leg 120, and so can contribute to further diversification of the legs 120.

Note that the modification example (1) to the modification example (4) of the third embodiment may be applied to the information processing device 10 of another embodiment or modification example or the like.

### Fourth Embodiment

### [Overview of Mobile Body According to Fourth Embodiment]

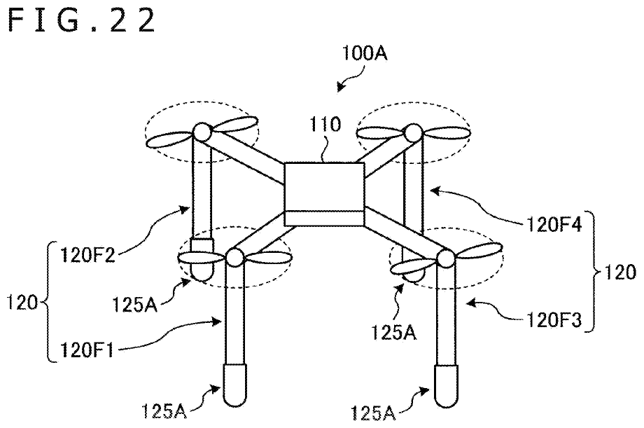

Next, a fourth embodiment is explained. In the fourth embodiment to be explained, the mobile body is an aerial vehicle. FIG. 22 is a perspective view for explaining one example of a mobile body according to the fourth embodiment. A mobile body 100A depicted in FIG. 22 is an aerial vehicle. For example, the mobile body 100A includes a drone that is capable of autonomous movement, an unmanned aerial vehicle (UAV), and the like.

In the example depicted in FIG. 22, the mobile body 100A has the body 110 and the four legs 120. For example, the body 110 is a trunk of the mobile body 100A. For example, the body 110A has a device that controls autonomous movement and the like. In addition, when distinctions are made among the four legs 120 in the following explanation, the four legs 120 are referred to as a leg 120F1, a leg 120F2, a leg 120F3, and a leg 120F4, as appropriate.

The legs 120 protrude from the body 110 and support the body 110 in a case that the mobile body 100A is landed. While the legs 120 are explained as being protruding from the body 110 and provided with rotors in the present embodiment, this configuration is not the sole configuration. In a case that the mobile body 100A is floating, flying, and so on, the legs 120 are in a state where they are not in contact with the external environment. In a case that the mobile body 100A is landed, the legs 120 are in a state where they are in contact with the external environment.

The contact sections 125A are provided to the tips of the legs 120 such that they can contact the external environment. In the example depicted in FIG. 22, the contact sections 125A are provided to protrude from the tips of the legs 120. The contact sections 125A are formed as hollow sections with an elastic member, for example, such that they deform in a case that they come into contact with the external environment.

### [Configuration of Mobile Body According to Fourth Embodiment]

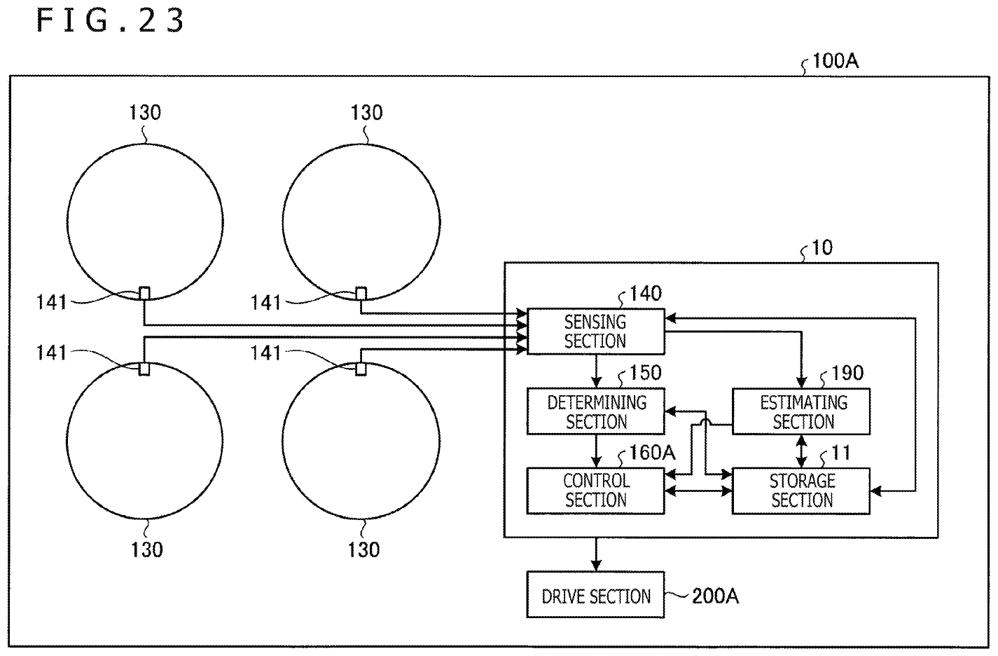

FIG. 23 is a figure depicting one example of the configuration of the mobile body 100A according to the fourth embodiment. As depicted in FIG. 23, the mobile body 100A includes the plural filled sections 130, the information processing device 10, and a drive section 200A. The drive section 200A includes various types of devices related to a driving system of the mobile body 100A, which is an aerial vehicle. For example, the drive section 200A includes driving force generating devices for generating a driving force such as plural drive motors, and the like. The drive motors rotate the rotors of the mobile body 100A, for example. For example, the drive section 200A rotates the drive motors on the basis of control information including a command from the information processing device 10 and the like, and thereby the mobile body 100A floats, flies, and lands.

Each of the plural filled sections 130 is provided corresponding to one of the plural legs 120. The filled sections 130 are provided to portions of the legs 120 at which the legs 120 contact the external environment. The filled sections 130 are made deformable by being formed like bags with elastic members, for example. The filled sections 130 are formed such that their inner spaces can be filled with a fluid. The fluid includes a gas, a liquid, or the like, for example. Each of the plural filled sections 130 is housed in the inner space of one of the contact sections 125A of the plural legs 120. While the filled sections 130 are provided to the protruding contact sections 125A of the legs 120 in the mobile body 100A in the present embodiment explained, this is not the sole example. For example, the contact sections 125A in the mobile body 100A may be realized by wheels or the like, similarly to the first embodiment mentioned above, and the like.

The information processing device 10 includes the storage section 11, the sensing section 140, the determining section 150, a control section 160A, and the estimating section 190. For example, the information processing device 10 is provided to the body 110 of the mobile body 100A. In the present embodiment, each processing section of the sensing section 140, the determining section 150, the control section 160A, and the estimating section 190 is realized by a program stored on the information processing device 10 being executed by a CPU, an MCU, or the like by using a RAM or the like as a work area, for example. In addition, each processing section may be realized by an integrated circuit such as an ASIC or an FPGA, for example.

The determining section 150 determines the state of the legs 120 of the mobile body 100A on the basis of a pressure variation sensed by the sensing section 140. In a case that variations of the internal pressures of the filled sections 130 occur, the determining section 150 determines that the legs 120 have made a transition to the contact state or the non-contact state. The determining section 150 can use plural contact determination methods. For example, if pressure variations that make pressure values represented by pressure information equal to or larger than a preset threshold are sensed in a case that the legs 120 are in the non-contact state, the determining section 150 determines that the legs 120 have made a transition to the contact state. That is, in a case that it is determined that there has been a transition to the contact state, the determining section 150 can determine that the legs 120 of the mobile body 100A are in contact with the external environment. For example, if pressure variations that make pressure values represented by pressure information smaller than a predetermined threshold are sensed in a case that the legs 120 are in the contact state, the determining section 150 determines that the legs 120 have made a transition to the non-contact state. That is, in a case that it is determined that there has been a transition to the non-contact state, the determining section 150 can determine that the legs 120 of the mobile body 100A have detached from the external environment. The determining section 150 determines the state of each of the plural legs 120. The determining section 150 is electrically connected with the control section 160A and outputs determination information representing a result of the determination to the control section 160A. For example, the determination information represents a result of the determination about each of the plural legs 120.

The control section 160A controls operation of the mobile body 100A on the basis of a determination result of the determining section 150. The control section 160A operates the mobile body 100A by controlling driving of the drive section 200A of the mobile body 100A. The control section 160A performs flight control of the mobile body 100A for realizing an action plan of the mobile body 100A. In a case that the mobile body 100A is landed, the control section 160A executes a task, a process, or the like set for the time of landing. The control section 160A outputs an operation command for driving the mobile body 100A and the like to the drive section 200A.

For example, in a case that a location where the mobile body 100A is landed is unstable, the control section 160A performs control for causing the mobile body 100A to change the landing position. For example, if the estimating section 190 estimates that the external environment is uneven, the control section 160A executes control for changing the landing position of the mobile body 100A. If the estimating section 190 estimates that the external environment is not uneven, the control section 160A executes a process for the time of landing to land the mobile body 100A.

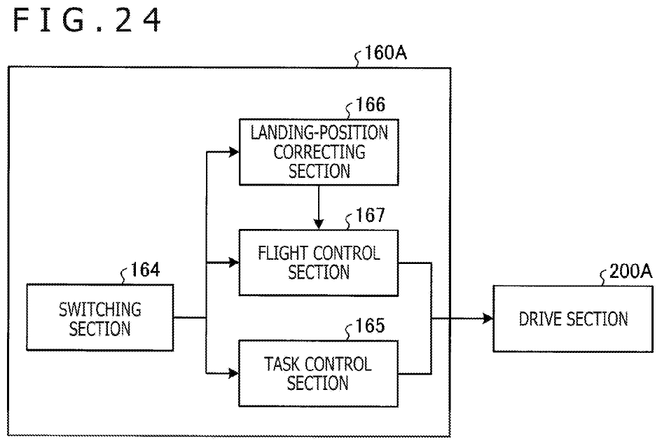

FIG. 24 is a figure depicting one example of the configuration of the control section 160A of the information processing device 10 according to the fourth embodiment. The control section 160A depicted in FIG. 24 includes a switching section 164, a task control section 165, a landing-position correcting section 166, and a flight control section 167. The switching section 164 switches the control at the control section 160A on the basis of a determination result of the determining section 150 and an estimation result of the estimating section 190. For example, the switching section 164 causes the task control section 165, the landing-position correcting section 166, and the flight control section 167 to be executed selectively.

The task control section 165 controls tasks to be performed by the mobile body 100A after landing. For example, the tasks include receiving and passing carried objects housed in the body 110, outputting various types of information, and the like. The task control section 165 outputs control parameters according to tasks and the like to the drive section 200A, for example. Thereby, the drive section 200A causes the mobile body 100A to operate on the basis of the control parameters and the like.

If the estimating section 190 estimates that the external environment is uneven, the landing-position correcting section 166 corrects the landing position of the mobile body 100A. For example, the landing-position correcting section 166 computes a new landing position and creates an action plan for moving to the landing position. For example, the action plan includes a plan for causing the mobile body 100A to take off, flying the mobile body 100A to the landing position, and then landing the mobile body 100A. The landing-position correcting section 166 outputs the created new action plan to the flight control section 167.

The flight control section 167 performs flight control of the mobile body 100A by driving the drive section 200A. For example, the flight control section 167 performs flight control for realizing an action plan of the mobile body 100A. The flight control section 167 outputs an operation command for driving the mobile body 100A and the like to the drive section 200A. The flight control section 167 outputs, to the drive section 200A, an operation command based on the action plan created by the landing-position correcting section 166 and the like. As a result, the information processing device 10 realizes flight operation, floating operation, landing operation, stopping operation, and other operation of the mobile body 100A.

A configuration example of the information processing device 10 according to the fourth embodiment is explained thus far. Note that the configuration described above explained by using FIG. 123 is merely one example, and the configuration of the information processing device 10 according to the fourth embodiment is not limited to the example. The functional configuration of the information processing device 10 according to the fourth embodiment can be modified flexibly in accordance with specifications and use.

### [Processing Procedure of Information Processing Device According to Fourth Embodiment]

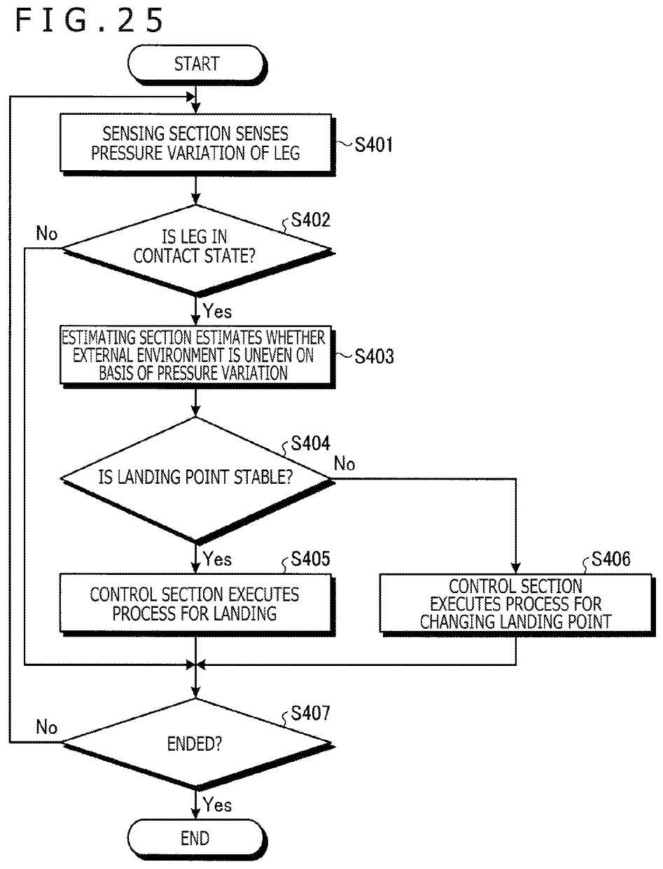

Next, one example of a processing procedure of the information processing device 10 according to the fourth embodiment is explained. FIG. 25 is a flowchart depicting one example of the processing procedure executed by the information processing device 10 according to the fourth embodiment. The processing procedure depicted in FIG. 25 is realized by the information processing device 10 executing a program. The processing procedure depicted in FIG. 25 is executed by the information processing device 10 in a case that the mobile body 100A performs landing operation.

As depicted in FIG. 25, in the information processing device 10, the sensing section 140 senses pressure variations of the legs 120 (Step S401). Then, on the basis of the sensing result at Step S401, the information processing device 10 determines whether or not the legs 120 are in the contact state (Step S402). For example, in a case that pressure variations are sensed at the plural filled sections 130, the information processing device 10 determines that the legs 120 are in the contact state. In a case that it is determined that the legs 120 are not in the contact state (No at Step S402), the information processing device 10 proceeds to the process at Step S407 mentioned below. In addition, in a case that it is determined that the legs 120 are in the contact state (Yes at Step S402), the information processing device 10 proceeds to the process at Step S403.

In the information processing device 10, the estimating section 190 estimates whether the external environment is uneven on the basis of the pressure variations (Step S403). For example, the estimating section 190 estimates whether the external environment is uneven for each of the plural legs 120, and also estimates whether the external environment is uneven on the basis of the contact state of the plural legs 120. In other words, the estimating section 190 estimates whether or not the external environment is a location where landing is possible on the basis of the contact state of the legs 120. Then, the information processing device 10 stores the estimation result on the storage section 11 and then proceeds to the process at Step S404.

On the basis of the estimation result, the information processing device 10 determines whether or not the landing point is stable (Step S404). For example, if the estimation result represents that the external environment is uneven, all the legs 120 have not been able to contact the external environment, or the like, the information processing device 10 determines that the landing point is not stable. In a case that it is determined that the landing point is stable (Yes at Step S404), the information processing device 10 proceeds to the process at Step S405. In the information processing device 10, the control section 160A executes a process for the time of landing (Step S405). For example, in the information processing device 10, the task control section 165 controls tasks to be performed by the mobile body 100A after landing. Then, when the process of Step S405 ends, the information processing device 10 proceeds to the process at Step S407 mentioned below.

In addition, in a case that it is determined that the landing point is not stable (No at Step S404), the information processing device 10 proceeds to the process at Step S406. In the information processing device 10, the control section 160A executes a process for changing the landing point (Step S406). For example, in the information processing device 10, the landing-position correcting section 166 changes the landing position of the mobile body 100A, and the flight control section 167 controls the drive section 200A of the mobile body 100A such that the mobile body 100A lands at the changed landing position. Then, when the process of Step S406 ends, the information processing device 10 proceeds to the process at Step S407.

The information processing device 10 determines whether or not to end the process (Step S407). In a case that it is determined not to end the process (No at Step S407), the information processing device 10 returns to the process at Step S401 explained already and continues the processing procedure from Step S401. In addition, in a case that it is determined to end the process (Yes at Step S407), the information processing device 10 ends the processing procedure depicted in FIG. 25.

### [Operation of Mobile Body According to Fourth Embodiment]

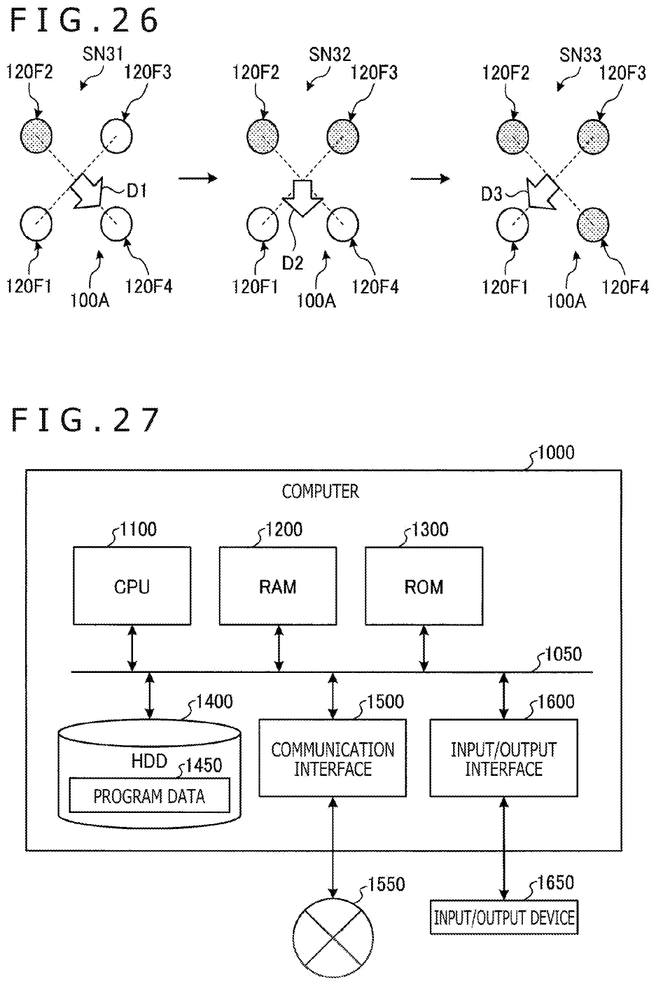

Next, one example of operation of the mobile body 100A is explained with reference to FIG. 26. FIG. 26 is a figure depicting examples of operation according to landing of the mobile body 100A and the external environment according to the fourth embodiment. In a scene SN31 in FIG. 26, the mobile body 100A is landed, the external environment where the leg 120F2 is touching a ground is uneven, and the external environment where the other legs 120 are touching the ground is a flat ground. In this case, in the information processing device 10, the sensing section 140 senses a pressure variation at each of the four legs 120, and it is estimated that only the external environment where the leg 120F2 is touching the ground is uneven, on the basis of the pressure variations. Then, the information processing device 10 changes the landing position to a position near the mobile body 100A where the external environment is not uneven. In the example represented by the scene SN31, because it is likely that the external environment where the legs other than the leg 120F2 are touching the ground is a flat ground, the information processing device 10 controls operation of the mobile body 100A such that the ground-touching position of the mobile body 100A is moved in a direction D1.

In a scene SN32, the mobile body 100A is landed, the external environment where the legs 120F2 and 120F3 are touching the ground is uneven, and the external environment where the other legs 120 are touching the ground is a flat ground. In this case, in the information processing device 10, the sensing section 140 senses a pressure variation at each of the four legs 120, and it is estimated that the external environment where the legs 120F2 and 120F3 are touching the ground is uneven, on the basis of the pressure variations. Then, the information processing device 10 changes the landing position to a position near the mobile body 100A where the external environment is not uneven. In the example represented by the scene SN32, because it is likely that the external environment where the legs 120 other than the legs 120F2 and 120F3 are touching the ground is a flat ground, the information processing device 10 controls operation of the mobile body 100A such that the ground-touching position of the mobile body 100A is moved in a direction D2.

In a scene SN33, the mobile body 100A is landed, the external environment where the legs 120F2, 120F3, and 120F4 are touching the ground is uneven, and the external environment where the other leg 120 is touching the ground is a flat ground. In this case, in the information processing device 10, the sensing section 140 senses a pressure variation at each of the four legs 120, and it is estimated that the external environment where the legs 120F2, 120F3, and 120F4 are touching the ground is uneven, on the basis of the pressure variations. Then, the information processing device 10 changes the landing position to a position near the mobile body 100A where the external environment is not uneven. In the example represented by the scene SN33, because it is likely that the external environment where the leg 120 other than the legs 120F2, 120F3, and 120F4 are touching the ground is a flat ground, the information processing device 10 controls operation of the mobile body 100A such that the ground-touching position of the mobile body 100A is moved in a direction D3.

As mentioned above, in the information processing device 10 according to the fourth embodiment, if the estimating section 190 estimates that the external environment is uneven in a case that the mobile body 100A is an aerial vehicle, the control section 160A executes control for changing the landing position of the mobile body 100A. Thereby, the information processing device 10 can change the landing position according to the state of the external environment where the mobile body 100A is about to land as to unevenness of the external environment. As a result, the information processing device 10 can use the filled sections 130 to avoid landing of the mobile body 100A in the external environment which is an uneven point, and so can improve the safety of the mobile body 100A.

In addition, in the information processing device 10, the control section 160A executes control of landing the mobile body 100A if the estimating section 190 estimates that the external environment is not uneven. Thereby, the information processing device 10 can land the mobile body 100A in a case that it is estimated that the external environment where the mobile body 100A is about to land is not uneven. As a result, the information processing device 10 can use the filled sections 130 to land the mobile body 100A in a stable external environment, and so can ensure the stability of the landed mobile body 100A.

The fourth embodiment mentioned above represents one example and can be changed and applied in various manners.

### [Hardware Configuration]

The information processing device 10 according to the first to fourth embodiments mentioned thus far may be realized by a computer 1000 with a configuration like the one depicted in FIG. 27, for example. Hereinafter, the information processing device 10 according to an embodiment is explained as an example. FIG. 27 is a hardware configuration diagram depicting one example of a computer 1000 that realizes functionalities of the information processing device 10. The computer 1000 has a CPU 1100, a RAM 1200, a ROM (Read Only Memory) 1300, an HDD (Hard Disk Drive) 1400, a communication interface 1500, and an input/output interface 1600. Each section of the computer 1000 is connected by a bus 1050.

The CPU 1100 operates on the basis of programs stored on the ROM 1300 or the HDD 1400 and performs control of each section. For example, the CPU 1100 loads programs stored on the ROM 1300 or the HDD 1400 onto the RAM 1200 and executes processes corresponding to various types of programs.

The ROM 1300 stores a boot program such as BIOS (Basic Input Output System) executed by the CPU 1100 at the time of activation of the computer 1000, programs that depend on the hardware of the computer 1000, or the like.

The HDD 1400 is a non-transitory computer-readable recording medium on which programs to be executed by the CPU 1100, data to be used by the programs, and the like are recorded. Specifically, the HDD 1400 is a recording medium on which information processing programs related to the present disclosure which are one example of program data 1450 are recorded.

The communication interface 1500 is an interface for the computer 1000 to be connected with an external network 1550 (e.g., the Internet). For example, the CPU 1100 receives data from other equipment or transmits data generated by the CPU 1100 to other equipment via the communication interface 1500.

The input/output interface 1600 is an interface for connecting an input/output device 1650 and the computer 1000. For example, the CPU 1100 receives data from input devices such as a keyboard or a mouse via the input/output interface 1600. In addition, the CPU 1100 transmits data to output devices such as a display, a speaker, or a printer via the input/output interface 1600. In addition, the input/output interface 1600 may also function as a media interface that reads out programs and the like recorded on predetermined recording media (media). For example, media are an optical recording medium such as a DVD (Digital Versatile Disc), a magneto-optical recording medium such as an MO (Magneto-Optical disk), a tape medium, a magnetic recording medium, a semiconductor memory, or the like.

For example, in a case that the computer 1000 functions as the information processing device 10 according to the embodiment, the CPU 1100 of the computer 1000 executes a program loaded onto the RAM 1200 to thereby realize functionalities such as the sensing section 140, the determining section 150, the control section 160, the setting section 170, the deciding section 180, or the estimating section 190. In addition, the HDD 1400 stores a program related to the present disclosure and data in the storage section 11. Note that, while the CPU 1100 reads out the program data 1450 from the HDD 1400 and executes the program data 1450, the CPU 1100 may acquire those programs from another apparatus via the external network 1550, as another example.

While suitable embodiments of the present disclosure are explained in detail with reference to the attached figures thus far, the technical scope of the present disclosure is not limited to those examples. It is obvious that those with ordinary knowledge in the technical field of the present disclosure can conceive of various types of modified examples or corrected examples within the scope of the technical idea described in claims, and those various types of modified examples or corrected examples are certainly deemed to belong to the technical scope of the present disclosure.

In addition, the advantages described in the present specification are presented merely for explanation or illustration, but not for limitation. That is, the technology according to the present disclosure can exhibit other advantages that are obvious for those skilled in the art from the description of the present specification, along with the advantages described above, or instead of the advantages described above.

In addition, a program for causing hardware such as a CPU, a ROM, or a RAM built in a computer to exhibit functionalities equivalent to configurations that the information processing device 10 has can also be created, and a computer-readable recording medium on which the program is recorded also can be provided.

In addition, each step according to processes of the information processing device 10 of present specification needs not necessarily be processed in a time series along an order described in a flowchart. For example, each step according to processing of the information processing device 10 may be processed in an order different from an order described in a flowchart or may be processed in parallel.

In addition, while the information processing device 10 is explained as being provided to the mobile body 100 or the mobile body 100A in the first to fourth embodiments, this is not the sole example. For example, the information processing device 10 may be provided outside the mobile body 100 or the mobile body 100A. In this case, for example, it is sufficient if the information processing device 10 enables transmission and reception of various types of information to and from the mobile body 100 or the mobile body 100A by communication via a communication apparatus, and acquires pressure information regarding the filled sections 130 or the like provided to the legs 120.

In addition, the information processing device 10 depicted in the first to fourth embodiments can use pressures of a fluid in the plural filled sections 130 or the like to compute a pressure centroid position of the mobile body 100 or 100A. For example, the information processing device 10 can compute the pressure centroid position on the basis of the pressures of the fluid in the plural filled sections 130 in contact with the external environment. By computing the pressure centroid position, the information processing device 10 can assist control of the posture of the mobile body 100 or 100A, and the like. One example of a computation method of the information processing device 10 is explained below with reference to FIG. 1 mentioned above.

For example, the information processing device 10 of the mobile body 100 depicted in FIG. 1 treats a pressure of the fluid of a filled section 130 sensed at a contact point i of each of the leg 120A, the leg 120B, the leg 120C, and the leg 120D of the mobile body 100 as pᵢ. Note that i is an integer. For example, the information processing device 10 senses pressures of the leg 120A, the leg 120B, the leg 120C, and the leg 120D as a pressure p₁, a pressure P₂, a pressure p₃, and a pressure p₄, respectively. In addition, the information processing device 10 treats coordinates of the contact point i as coordinates xᵢ. For example, the information processing device 10 treats a contact point of the leg 120A, a contact point of the leg 120B, a contact point of the leg 120C, and a contact point of the leg 120D as coordinates x₁, coordinates x₂, coordinates x₃, and coordinates x₄, respectively. In this case, the information processing device 10 can compute a pressure centroid x_{cop} by using Formula (1).

x_{cop}=Σᵢ(pᵢ*xᵢ)/Σᵢpᵢ Formula (1)

In addition, the pressure pᵢ in Formula (1) can be replaced with a difference from a reference pressure point. For example, a filling fluid pressure p₀ in a state where the legs 120 are not in contact with the external environment is measured in advance, and p₁ can be replaced with p_{Δ} as in Formula (2).

p_{Δ}=pᵢ−p₀ Formula (2)

The information processing device 10 can determine the pressure centroid also by replacing p₁ in Formula (1) with p_{Δ}. Note that the reference pressure point may have any value as long as the value is a pressure value measured in a state that the pressure centroid x_{cop} is at a center position of the mobile body 100.

### (Advantages)

The information processing device 10 includes the sensing section 140 that senses pressure variations of the fluid filling the deformable filled sections 130 that are provided to portions of the legs 120 of the mobile body 100 that are in either the contact state or the non-contact state at which portions the legs 120 contact the external environment, and the determining section 150 that determines the state of the legs 120 on the basis of the pressure variations sensed by the sensing section 140.

Thereby, only by providing the filled sections 130 to the contact portions of the legs 120, the information processing device 10 can determine whether or not the legs 120 are in the contact state. That is, the information processing device 10 makes it unnecessary to provide contact switches or the like for sensing contact to the legs 120, or to simplify the structure of the legs 120. In addition, the information processing device 10 can determine the state of the legs 120 without complicating the structure even if the contact portions of the legs 120 are enlarged. As a result, the information processing device 10 makes it possible to provide the filled sections 130 with shapes according to the contact portions of the legs 120, and so can allow diversification of the structure of the legs 120 of the mobile body 100. In addition, the information processing device 10 makes it possible to absorb an impact caused by contact between the external environment and the legs 120 by the filled sections 130 for sensing pressure variations, and so can suppress malfunctions caused by the impact.

The information processing device 10 further includes the control section 160 that controls driving of the legs 120 on the basis of a determination result of the determining section 150.

Thereby, the information processing device 10 can control driving of the legs 120 according to the contact state or the non-contact state of the legs 120 of the mobile body 100. As a result, the information processing device 10 can perform driving according to the contact state even if wheels are provided to the tips of the legs 120, and so can contribute to further diversification of the legs 120.

In the information processing device 10, the control section 160 performs the first control according to the contact state in a case that a determination result of the determining section 150 represents that the legs 120 are in the contact state, and performs the second control according to the non-contact state in a case that a determination result of the determining section 150 represents that the legs 120 are in the non-contact state.

Thereby, the information processing device 10 performs the first control such as the force control of the legs 120 in a case that the legs 120 of the mobile body 100 are in the contact state, and performs the second control such as the position control of the legs 120 in a case that the legs 120 of the mobile body 100 are in the non-contact state. As a result, the information processing device 10 can switch to control according to the state of the legs 120 even if the mobile body 100 includes plural legs 120, and so can allow diversification of the plural legs 120.

In the information processing device 10, each of the filled sections 130 is divided into the plural segments 131 each having a closed inner space, the sensing section 140 senses pressure variations of the fluid filling each of the plural segments 131, and the determining section 150 determines the state of the legs 120 on the basis of a segment 131 where a pressure variation is sensed by the sensing section 140.

Thereby, the information processing device 10 can recognize a relation between a position where a leg 120 is in contact with the external environment and pressure variations, on the basis of the arrangement of the segments 131 of the filled sections 130. As a result, by using the filled sections 130 each of which is divided into the plural segments 131, the information processing device 10 can improve the resolution regarding a position where a pressure variation is sensed, and so can contribute to further diversification of the legs 120.

In the information processing device 10, the determining section 150 determines that there is a collision of a leg 120 on the basis of the position of a segment 131 of a filled section 130A where a pressure variation is sensed by the sensing section 140.

Thereby, for example, in a case that the position of a segment 131 where a pressure variation is sensed is different from a contact position which should be in contact with the external environment, the information processing device 10 can determine that there is a collision of a leg 120. As a result, the information processing device 10 can determine whether there is contact or a collision of a leg 120 with the external environment only by using the filled sections 130A without complicating the structure of the legs 120, and so can contribute to further diversification of the legs 120.

The information processing device 10 further includes the estimating section 190 that estimates the state of the external environment with which the legs 120 are in contact, on the basis of the pressure variations sensed by the sensing section 140, and the control section 160 changes control of the mobile body 100 on the basis of the state of the external environment estimated by the estimating section 190.

Thereby, the information processing device 10 can estimate the state of the external environment on the basis of pressure variations of the filled sections 130. As a result, the information processing device 10 can estimate the state of the external environment without complicating the structure of the legs 120, and so can contribute to further diversification of the legs 120.

In the information processing device 10, the estimating section 190 estimates the state of the external environment with which the legs 120 are in contact as to unevenness of the external environment, on the basis of the pressure variations sensed by the sensing section 140, and if the estimating section 190 estimates that the external environment is uneven, the control section 160 changes the control of the legs 120 to the third control according to the unevenness.

Thereby, the information processing device 10 can estimate whether or not the external environment has protrusions and recesses on the basis of pressure variations of the filled sections 130. As a result, the information processing device 10 can estimate the state of the external environment as to unevenness of the external environment without complicating the structure of the legs 120, and so can contribute to further diversification of the legs 120.

In the information processing device 10, the estimating section 190 estimates the state of the external environment with which the legs 120 are in contact as to unevenness of the external environment, on the basis of a pattern of pressure variations sensed by the sensing section 140.

Thereby, by estimating unevenness on the basis of a pattern of pressure variations of the filled sections 130, the information processing device 10 can exclude pressure variations caused by noise or the like from targets of estimation. As a result, the information processing device 10 can extract pressure variations of the filled sections 130 caused by the unevenness of the external environment, and so can improve the unevenness estimation precision.

In the information processing device 10, in a case the mobile body 100 has a configuration capable of moving by using wheels provided to the legs 120 and of walking by using the legs 120, the control section 160 performs control such that the mobile body 100 moves by using the wheels if the estimating section 190 estimates that the external environment is uneven, and performs control such that the mobile body 100 walks by using the legs 120 if the estimating section 190 estimates that the external environment is not uneven.

Thereby, the information processing device 10 can switch the movement of the mobile body 100 between movement by using the wheels of the mobile body 100 and movement by walking by using the legs 120, according to the state of the external environment as to unevenness of the external environment. As a result, even if the configuration of the legs 120 becomes complicated, the information processing device 10 can determine the state of the legs 120 by using the filled sections 130 and also estimate the state of the external environment as to unevenness of the external environment, and so can contribute to further diversification of the legs 120.

In the information processing device 10, the mobile body 100 is provided with the adjusting section 300 for adjusting the pressures of the fluid filling the inner spaces of the filled sections 130, and if the estimating section 190 estimates that the external environment is uneven, the control section 160 performs control of the legs 120 such that the adjusting section 300 adjusts internal pressures of the filled sections 130 on the basis of the unevenness.

Thereby, the information processing device 10 can adjust the internal pressures of the filled sections 130 according to the unevenness of the external environment. As a result, because the information processing device 10 can change the area of contact and the friction force of contact between the legs 120 of the mobile body 100 and the external environment by adjusting the internal pressures of the filled sections 130, it is possible to attempt to improve the degree of freedom of the contact sections 125 of the legs 120 and also to simplify the control.

In the information processing device 10, each of the filled sections 130 is divided into the plural segments 132 each having a closed inner space, the sensing section 140 senses pressure variations of the fluid filling each of the plural segments 132, and the estimating section 190 estimates the state of the external environment with which the legs 120 of the mobile body 100 are in contact, on the basis of a distribution of segments 132 where pressure variations are sensed by the sensing section 140.

Thereby, the information processing device 10 can estimate the state of the external environment with which the legs 120 of the mobile body 100 are in contact, on the basis of a distribution of segments where pressure variations are sensed. As a result, by using the filled sections 130 each of which is divided into the plural segments 132, the information processing device 10 can estimate the state of the external environment with which the legs 120 are in contact as to unevenness of the external environment and so on, and so can contribute to further diversification of the legs 120.

In the information processing device 10, the estimating section 190 estimates the state of the external environment with which the legs 120 of the mobile body 100 are in contact, on the basis of pressure variations sensed by the sensing section 140 and the leg positions of the legs 120 relative to the reference position.

Thereby, the information processing device 10 can estimate the state of the external environment with which the legs 120 of the mobile body 100 are in contact, on the basis of a relation between pressure variations and the positions of the legs 120. As a result, only by using the filled sections 130 with a simple structure, the information processing device 10 can estimate the state of the external environment with which the legs 120 are in contact as to unevenness of the external environment and so on, and so can contribute to further diversification of the legs 120.

In the information processing device 10, the estimating section 190 estimates the state of the external environment as to unevenness of the external environment and whether there is a collision of a leg, on the basis of a change of a pressure variation sensed by the sensing section 140.

Thereby, the information processing device 10 can estimate whether the external environment is uneven and whether there is a collision of a leg 120 of the mobile body 100, on the basis of a change of a sensed pressure variation. As a result, only by using the filled sections 130, the information processing device 10 can estimate the state of the external environment with which the legs 120 are in contact as to unevenness of the external environment and estimate whether there is a collision of a leg 120, and so can contribute to further diversification of the legs 120.

In the information processing device 10, the mobile body 100A is an aerial vehicle, the estimating section 190 estimates the state of the external environment with which the legs 120 are in contact as to unevenness of the external environment on the basis of the pressure variations sensed by the sensing section 140, and if the estimating section 190 estimates that the external environment is uneven, the control section 160A executes control for changing a landing position of the mobile body.

Thereby, the information processing device 10 can change the landing position according to the state of the external environment where the mobile body 100A is about to land as to unevenness of the external environment. As a result, the information processing device 10 can use the filled sections 130 to avoid landing of the mobile body 100A in the external environment which is an uneven point, and so can improve the safety of the mobile body 100A.

In the information processing device 10, if the estimating section 190 estimates that the external environment is not uneven, the control section 160A executes control of landing the mobile body 100A.

Thereby, the information processing device 10 can land the mobile body 100A in a case that it is estimated that the external environment where the mobile body 100A is about to land is not uneven. As a result, the information processing device 10 can use the filled sections 130 to land the mobile body 100A in a stable external environment, and so can ensure the stability of the landed mobile body 100A.

In the information processing device 10, the determining section 150 determines the state of the legs 120 on the basis of a result of comparison between the pressure variations sensed by the sensing section 140 and a preset threshold.

Thereby, the information processing device 10 can determine the state of the legs 120 by comparing pressure variations and the threshold. As a result, the information processing device 10 can suppress an increase of processing load even if the number of the plural legs 120 increases, and so can allow diversification of the plural legs 120.

The information processing device 10 further includes the setting section 170 that sets the threshold on the basis of pressures of the filled sections 130 sensed by the sensing section 140 when the legs 120 are in the contact state, and pressures of the filled sections 130 sensed by the sensing section 140 when the legs 120 are in the non-contact state.

Thereby, the information processing device 10 can set the thresholds suited for situations even if the fluid in the filled sections 130 flows out, is influenced by ageing, and so on. As a result, the information processing device 10 can suppress deterioration of the precision in determining the state of the legs 120 on the basis of pressure variations of the filled sections 130, even if the filled sections 130 are provided to the legs 120.

The mobile body 100 includes the legs 120 that are in either the contact state or the non-contact state, the deformable filled sections 130 that are provided to portions of the legs 120 at which the legs 120 contact the external environment, the sensing section 140 that senses pressure variations of the fluid filling the filled sections 130, and the determining section 150 that determines the state of the legs 120 on the basis of the pressure variations sensed by the sensing section 140.

Thereby, only by providing the filled sections 130 to the contact portions of the legs 120, the mobile body 100 can determine whether or not the legs 120 are in the contact state. That is, the mobile body 100 makes it unnecessary to provide contact switches or the like for sensing contact to the legs 120, or to simplify the structure of the legs 120. In addition, the mobile body 100 can determine the state of the legs 120 without complicating the structure even if the contact portions of the legs 120 are enlarged. In addition, because the mobile body 100 can be realized by providing the filled sections 130 to the legs 120, an increase in weight of the legs 120 can be suppressed. As a result, the mobile body 100 makes it possible to provide the filled sections 130 with shapes according to the contact portions of the legs 120, and so can allow diversification of the structure of the legs 120. In addition, the mobile body 100 makes it possible to absorb an impact caused by contact between the external environment and the legs 120 by the filled sections 130 for sensing pressure variations, and so can suppress malfunctions caused by the impact.

A mobile-body-state determination method performed by a computer includes sensing, by the sensing section 140, pressure variations of the fluid filling the deformable filled sections 130 provided to portions of the legs 120 of the mobile body 100 that are in either the contact state or the non-contact state at which portions the legs 120 contact the external environment, and determining the state of the legs 120 on the basis of the sensed pressure variations.

Thereby, in the state determination method, only by providing the filled sections 130 to the contact portions of the legs 120, the computer can determine whether or not the legs 120 are in the contact state. That is, the state determination method can make it unnecessary to provide contact switches or the like for sensing contact to the legs 120, or to simplify the structure of the legs 120. In addition, in the state determination method, the computer can determine the state of the legs 120 without complicating the structure even if the contact portions of the legs 120 are enlarged. As a result, the state determination method makes it possible to provide the filled sections 130 with shapes according to the contact portions of the legs 120, and so can allow diversification of the structure of the legs 120. In addition, the state determination method makes it possible to absorb an impact caused by contact between the external environment and the legs 120 by the filled sections 130 for sensing pressure variations, and so can suppress malfunctions caused by the impact.

Note that configurations like the ones mentioned below also belong to the technical scope of the present disclosure.

(1)

An information processing device including:

a sensing section that senses a pressure variation of a fluid filling a deformable filled section that is provided to a portion of a leg of a mobile body that is in either a contact state or a non-contact state at which portion the leg contacts an external environment; and a determining section that determines a state of the leg on the basis of the pressure variation sensed by the sensing section.

(2)

The information processing device according to (1), further including:

a control section that controls driving of the leg on the basis of a determination result of the determining section.

(3)

The information processing device according to (2), in which the control section performs first control according to the contact state in a case that the determination result represents that the leg is in the contact state, and performs second control according to the non-contact state in a case that the determination result represents that the leg is in the non-contact state.

(4)

The information processing device according to any of (1) to (3), in which

the filled section is divided into plural segments each having a closed inner space,

the sensing section senses pressure variations of the fluid filling each of the plural segments, and

the determining section determines the state of the leg on the basis of a segment where a pressure variation is sensed by the sensing section.

(5)

The information processing device according to (4), in which the determining section determines whether there is a collision of the leg on the basis of a position of the segment where the pressure variation is sensed by the sensing section.

(6)

The information processing device according to (2) or (3), further including:

an estimating section that estimates a state of the external environment with which the leg is in contact, on the basis of the pressure variation sensed by the sensing section, in which

the control section changes control of the mobile body on the basis of the state of the external environment estimated by the estimating section.

(7)

The information processing device according to (6), in which

the estimating section estimates a state of the external environment with which the leg is in contact as to unevenness of the external environment, on the basis of the pressure variation sensed by the sensing section, and

if the estimating section estimates that the external environment is uneven, the control section changes control of the leg to third control according to the unevenness.

(8)

The information processing device according to (7), in which the estimating section estimates the state of the external environment with which the leg is in contact as to unevenness of the external environment, on the basis of a pattern of pressure variations sensed by the sensing section.

(9)

The information processing device according to (7) or (8), in which

in a case that the mobile body has a configuration capable of moving by using a wheel provided to the leg and of walking by using the leg,

the control section performs control such that the mobile body moves by using the wheel if the estimating section estimates that the external environment is uneven, and performs control such that the mobile body walks by using the leg if the estimating section estimates that the external environment is not uneven.

(10)

The information processing device according to any of (7) to (9), in which

the mobile body is provided with an adjusting section that adjusts a pressure of the fluid filling an inner space of the filled section, and

if the estimating section estimates that the external environment is uneven, the control section performs control of the leg such that the adjusting section adjusts an internal pressure of the filled section on the basis of the unevenness.

(11)

The information processing device according to any of (7) to (10), in which

the filled section is divided into plural segments each having a closed inner space,

the sensing section senses pressure variations of the fluid filling each of the plural segments, and

the estimating section estimates the state of the external environment with which the leg of the mobile body is in contact, on the basis of a distribution of segments where pressure variations are sensed by the sensing section.

(12)

The information processing device according to any of (7) to (11), in which the estimating section estimates the state of the external environment with which the leg of the mobile body is in contact, on the basis of the pressure variation sensed by the sensing section and a leg position of the leg relative to a reference position.

(13)

The information processing device according to any of (7) to (12), in which the estimating section estimates the state of the external environment as to unevenness of the external environment and whether there is a collision of the leg, on the basis of a change of the pressure variation sensed by the sensing section.

(14)

The information processing device according to (6), in which

the mobile body includes an aerial vehicle,

the estimating section estimates a state of the external environment with which the leg is in contact as to unevenness of the external environment, on the basis of the pressure variation sensed by the sensing section, and

if the estimating section estimates that the external environment is uneven, the control section executes control for changing a landing position of the mobile body.

(15)

The information processing device according to (14), in which, if the estimating section estimates that the external environment is not uneven, the control section executes control of landing the mobile body.

(16)

The information processing device according to any of (1) to (15), in which the determining section determines the state of the leg on the basis of a result of comparison between the pressure variation sensed by the sensing section and a preset threshold.

(17)

The information processing device according to (16), further including:

a setting section that sets the threshold on the basis of a pressure of the filled section sensed by the sensing section when the leg is in the contact state and a pressure of the filled section sensed by the sensing section when the leg is in the non-contact state.

(18)

A mobile body including:

a leg that is in either a contact state or a non-contact state;

a deformable filled section that is provided to a portion of the leg at which the leg contacts an external environment;

a sensing section that senses a pressure variation of a fluid filling the filled section; and

a determining section that determines a state of the leg on the basis of the pressure variation sensed by the sensing section.

(19)

A mobile-body-state determination method performed by a computer, the mobile-body-state determination method including:

sensing, by a sensing section, a pressure variation of a fluid filling a deformable filled section provided to a portion of a leg of a mobile body that is in either a contact state or a non-contact state at which portion the leg contacts an external environment; and

determining a state of the leg on the basis of the sensed pressure variation.

### REFERENCE SIGNS LIST

10: Information processing device
11: Storage section
100: Mobile body
100A: Mobile body
110: Body
120: Leg
125: Contact section
125A: Contact section
130: Filled section
130A: Filled section
130B: Filled section
140: Sensing section
141: Sensor
150: Determining section
160: Control section
161: Support-leg control section
162: Swing-leg control section
163: Actuator control section

1. An information processing device comprising:
a sensing section that senses a pressure variation of a fluid filling a deformable filled section that is provided to a portion of a leg of a mobile body that is in either a contact state or a non-contact state at which portion the leg contacts an external environment; and
a determining section that determines a state of the leg on a basis of the pressure variation sensed by the sensing section.

2. The information processing device according to claim 1, further comprising:
a control section that controls driving of the leg on a basis of a determination result of the determining section.

3. The information processing device according to claim 2, wherein the control section performs first control according to the contact state in a case that the determination result represents that the leg is in the contact state, and performs second control according to the non-contact state in a case that the determination result represents that the leg is in the non-contact state.

4. The information processing device according to claim 1, wherein
the filled section is divided into plural segments each having a closed inner space,
the sensing section senses pressure variations of the fluid filling each of the plural segments, and
the determining section determines the state of the leg on a basis of a segment where a pressure variation is sensed by the sensing section.

5. The information processing device according to claim 4, wherein the determining section determines whether there is a collision of the leg on a basis of a position of the segment where the pressure variation is sensed by the sensing section.

6. The information processing device according to claim 2, further comprising:
an estimating section that estimates a state of the external environment with which the leg is in contact, on a basis of the pressure variation sensed by the sensing section, wherein
the control section changes control of the mobile body on a basis of the state of the external environment estimated by the estimating section.

7. The information processing device according to claim 6, wherein
the estimating section estimates a state of the external environment with which the leg is in contact as to unevenness of the external environment, on a basis of the pressure variation sensed by the sensing section, and
if the estimating section estimates that the external environment is uneven, the control section changes control of the leg to third control according to the unevenness.

8. The information processing device according to claim 7, wherein the estimating section estimates the state of the external environment with which the leg is in contact as to unevenness of the external environment, on a basis of a pattern of pressure variations sensed by the sensing section.

9. The information processing device according to claim 7, wherein
in a case that the mobile body has a configuration capable of moving by using a wheel provided to the leg and of walking by using the leg,
the control section performs control such that the mobile body moves by using the wheel if the estimating section estimates that the external environment is uneven, and performs control such that the mobile body walks by using the leg if the estimating section estimates that the external environment is not uneven.

10. The information processing device according to claim 7, wherein
the mobile body is provided with an adjusting section that adjusts a pressure of the fluid filling an inner space of the filled section, and
if the estimating section estimates that the external environment is uneven, the control section performs control of the leg such that the adjusting section adjusts an internal pressure of the filled section on a basis of the unevenness.

11. The information processing device according to claim 7, wherein
the filled section is divided into plural segments each having a closed inner space,
the sensing section senses pressure variations of the fluid filling each of the plural segments, and
the estimating section estimates the state of the external environment with which the leg of the mobile body is in contact, on a basis of a distribution of segments where pressure variations are sensed by the sensing section.

12. The information processing device according to claim 7, wherein the estimating section estimates the state of the external environment with which the leg of the mobile body is in contact, on a basis of the pressure variation sensed by the sensing section and a leg position of the leg relative to a reference position.

13. The information processing device according to claim 7, wherein the estimating section estimates the state of the external environment as to unevenness of the external environment and whether there is a collision of the leg, on a basis of a change of the pressure variation sensed by the sensing section.

14. The information processing device according to claim 6, wherein
the mobile body includes an aerial vehicle,
the estimating section estimates a state of the external environment with which the leg is in contact as to unevenness of the external environment, on a basis of the pressure variation sensed by the sensing section, and
if the estimating section estimates that the external environment is uneven, the control section executes control for changing a landing position of the mobile body.

15. The information processing device according to claim 14, wherein, if the estimating section estimates that the external environment is not uneven, the control section executes control of landing the mobile body.

16. The information processing device according to claim 1, wherein the determining section determines the state of the leg on a basis of a result of comparison between the pressure variation sensed by the sensing section and a preset threshold.

17. The information processing device according to claim 16, further comprising:
a setting section that sets the threshold on a basis of a pressure of the filled section sensed by the sensing section when the leg is in the contact state and a pressure of the filled section sensed by the sensing section when the leg is in the non-contact state.

18. A mobile body comprising:
a leg that is in either a contact state or a non-contact state;
a deformable filled section that is provided to a portion of the leg at which the leg contacts an external environment;
a sensing section that senses a pressure variation of a fluid filling the filled section; and
a determining section that determines a state of the leg on a basis of the pressure variation sensed by the sensing section.

19. A mobile-body-state determination method performed by a computer, the mobile-body-state determination method comprising:
sensing, by a sensing section, a pressure variation of a fluid filling a deformable filled section provided to a portion of a leg of a mobile body that is in either a contact state or a non-contact state at which portion the leg contacts an external environment; and
determining a state of the leg on a basis of the sensed pressure variation.
